(19) United States
(12) Patent Application Publication
(10) Pub. No.: US 2023/0130589 A1
(43) Pub. Date: Apr. 27, 2023

(54) COMPOSITIONS CONTAINING PHASE CHANGE MATERIALS AND SYSTEMS INCLUDING THE SAME

(71) Applicant: PHASE CHANGE ENERGY SOLUTIONS, INC., Greensboro, NC (US)

(72) Inventors: Reyad I. Sawafta, Greensboro, NC (US); Venu Gopal Kuturu, Greensboro, NC (US); Brian S. Chapman, Greensboro, NC (US); Rami M. Saeed, Greensboro, NC (US)

(73) Assignee: PHASE CHANGE ENERGY SOLUTIONS, INC., Greensboro, NC (US)

(21) Appl. No.: 17/907,898

(22) PCT Filed: Feb. 26, 2021
(86) PCT No.: PCT/US2021/019966

§ 371 Date: Aug. 29, 2022

Related U.S. Application Data
(60) Provisional application No. 63/133,064, filed on Dec. 31, 2020.

(30) Foreign Application Priority Data
Feb. 28, 2020 (US) 62093101

(51) Int. Cl. C09K 5/06; F28D 20/02

(52) U.S. Cl. CPC C09K 5/063; F28D 20/021

(57) ABSTRACT

In one aspect, compositions are described herein which include a first phase change material (PCM) component comprising an organic PCM, a second PCM component comprising an inorganic PCM, and a crosslinker linking the first PCM component to the second PCM component. In another aspect, a thermal energy storage system is described herein which comprises a container, a heat exchanger disposed within the container, and a composition described herein disposed within the container. The heat exchanger and the composition of such thermal energy storage systems are in thermal contact with one another.

### RELATED APPLICATION DATA

The present application claims priority to U.S. Provisional Pat. Application 62/093,101, filed Feb. 28, 2020, and to U.S. Provisional Pat. Application 63/133,104, filed Dec. 31, 2020, each of which is hereby incorporated by reference in its entirety.

### FIELD

The present disclosure relates generally to compounds containing phase change materials and systems including the same.

### BACKGROUND

In recent years latent heat storage has become increasingly important in a wide array of technologies. Latent heat includes thermal energy released or absorbed during a change of state of a material without a substantial change in the temperature of the material. The change of state can include a phase change such as a solid-liquid, solid-gas, liquid-gas, or solid-solid phase change, including a crystalline solid to amorphous solid phase change.

Due to their latent heat storage properties, phase change materials (PCMs) have found application in a wide array of thermal energy technologies. However, the use of PCMs has been somewhat limited by disadvantages associated with the phase changes exhibited by some PCMs, including large volume changes, slow transitions, and/or flow in a liquid state.

### SUMMARY

Disclosed herein are compositions (or PCM compositions) comprising a first phase change material (PCM) component (or PCM composite) comprising an organic PCM, a second PCM component comprising an inorganic PCM, and a crosslinker linking the first PCM component to the second PCM component. Compositions disclosed herein are stable PCM composition with advantageous thermal, physical, and chemical properties. In some embodiments, the first PCM component includes a first linking component. In some embodiments, the second PCM component includes a second linking component.

In some embodiments, the first PCM component has a phase transition temperature range that is distinct from the phase transition temperature range of the second PCM component such that the composition including the first and second PCM components have two distinct phase transition temperature ranges. In some embodiments, the first PCM component has a phase transition temperature range that is similar to or the same as the phase transition temperature range of the second PCM component.

Also disclosed herein are methods of making compositions described herein. In some embodiments, a method of making a composition (or PCM composition) comprises providing a first PCM component, providing a second PCM component, providing a crosslinker, and combining the first PCM component and the second PCM component with the crosslinker.

In some embodiments, providing a first PCM component includes forming a gel. In some embodiments, providing a second PCM component includes forming a gel. In some embodiments, the first PCM component forms a first gel (or crosslinked network), the second PCM component forms a second gel (or crosslinked network) and the first gel (or crosslinked network) and the second gel (or crosslinked network) are crosslinked to one another after formation of the first gel (or crosslinked network) and/or after formation of the second gel (or crosslinked network), or the first gel (or crosslinked network) and the second gel (or crosslinked network) are crosslinked to one another simultaneously with formation of the first gel or crosslinked network and/or simultaneously with formation of the second gel or crosslinked network.

Also disclosed herein are thermal energy storage and/or management systems. In some embodiments, a thermal energy storage system described herein comprises a container, a heat exchanger disposed within the container, and a PCM (or PCM composition) disposed within the container, wherein the heat exchanger comprises an inlet pipe or header, an outlet pipe or header, and a number n of thermal transfer or heat exchange plates in fluid communication with the inlet pipe and the outlet pipe such that a fluid flowing from the inlet pipe and to the outlet pipe flows through the plates in between the inlet pipe and the outlet pipe, wherein the PCM is in thermal contact with the plates, and wherein the number n is at least 2.

Methods of storing and releasing thermal energy are also described herein. In some cases, such methods comprise attaching a thermal energy storage or management system described herein to an external source of an external fluid. In some implementations, the external fluid is liquid water. Additionally, the external source of the external fluid can comprise an HVAC chiller or a source of waste heat. Moreover, methods described herein, in some instances, further comprise forcing a first portion of the external fluid through the heat exchanger of the thermal energy system. In such embodiments, the first portion of the external fluid enters the heat exchanger of the system through a proximal end and exits the heat exchanger through a distal end, having passed through the plates of the heat exchanger.

These and other implementations are described in more detail in the detailed description which follows.

### BRIEF DESCRIPTION OF THE DRAWINGS

FIG. 1 illustrates an exploded perspective view of a thermal energy storage system according to one embodiment described herein.

FIG. 2 illustrates a sectional side view of the thermal energy storage system of FIG. 1.

FIG. 3 illustrates an adjacent side view of the thermal energy storage system of FIG. 2.

FIG. 4 illustrates a top plan view of the thermal energy storage system of FIG. 1.

FIG. 5 illustrates a side view of a pair of heat transfer plates that may be included in some embodiments of a thermal energy storage system described herein.

FIG. 6 illustrates a sectional view of a heat transfer plate that may be included in some embodiments of a thermal energy storage system described herein.

FIG. 7 illustrates an exploded perspective view of a thermal energy storage system according to one embodiment described herein.

FIG. 8 illustrates a sectional side view of the thermal energy storage system of FIG. 7.

FIG. 9 illustrates a perspective view of a heat exchanger that may be included in some embodiments of a thermal energy storage system described herein.

FIG. 10A illustrates a perspective view of a thermal energy storage system according to one embodiment described herein.

FIG. 10B illustrates a perspective view of a thermal energy storage system according to one embodiment described herein.

FIG. 11A illustrates a perspective view of a thermal energy management system comprising a stack of three thermal energy storage systems, in accordance with one embodiment described herein.

FIG. 11B illustrates a perspective view of a thermal energy management system having twelve thermal energy storage systems, in accordance with one embodiment described herein.

### DETAILED DESCRIPTION

In the following detailed description of the embodiments of the instant disclosure, numerous specific details are set forth in order to provide a thorough understanding of the disclosed embodiments. However, it will be obvious to one skilled in the art that the embodiments of this disclosure may be practiced without these specific details. In other instances, well known methods, procedure, components, and circuits have not been described in detail so as not to unnecessarily obscure aspects of the embodiments of the instant disclosure.

The following explanations of terms and methods are provided to better describe the present disclosure and to guide those of ordinary skill in the art in the practice of the present disclosure. The singular terms “a,” “an,” and “the” include plural referents unless context clearly indicates otherwise. Similarly, the word “or” is intended to include “and” unless the context clearly indicates otherwise. The term “comprises” means “includes.” Thus, “comprising A or B,” means “including A, B, or A and B,” without excluding additional elements. The term “about” will be understood by persons of ordinary skill in the art. Whether the term “about” is used explicitly or not, every quantity given herein refers to the actual given value, and it is also meant to refer to the approximation to such given value that would be reasonably inferred based on the ordinary skill in the art.

### I. Compositions Comprising Phase Change Materials

Disclosed herein are compositions (or PCM compositions) comprising a first phase change material (PCM) component (or PCM composite) comprising an organic PCM, a second PCM component comprising an inorganic PCM, and a crosslinker linking the first PCM component to the second PCM component. Compositions described herein are stable PCM compositions with advantageous thermal, physical, and chemical properties.

In some embodiments, the first PCM component has a phase transition temperature range that is distinct from the phase transition temperature range of the second PCM component such that a composition including the first and second PCM components have two distinct phase transition temperature ranges.

In some embodiments, the first PCM component is a first mixture and the second PCM component is a second mixture. In some embodiments, combining a first mixture with a second mixture is carried out after forming a gel in the first mixture and/or forming a gel in the second mixture. Combining the first mixture with the second mixture after forming a gel in the first mixture and/or forming a gel in the second mixture, in some embodiments, permits non-competitive thickening of the first and second mixtures.

In some embodiments, the first mixture is a gel and the second mixture is a pre-gel (or pre-crosslinked network) mixture when combining the first and second mixtures. In some embodiments, the first mixture is a pre-gel (or pre-crosslinked network) mixture and the second mixture is a gel when combining the first and second mixtures. In some embodiments, the first mixture is a gel and the second mixture is a gel when combining the first and second mixtures. In some embodiments, the first mixture is a pre-gel (or pre-crosslinked) mixture and the second mixture is also a pre-gel (or pre-crosslinked network) mixture when combining the first and second mixtures. In some embodiments, the first PCM component forms a first gel (or crosslinked network), the second PCM component forms a second gel (or crosslinked network) and the first gel (or crosslinked network) and the second gel (or crosslinked network) are crosslinked to one another after formation of the first gel (or crosslinked network) and/or after formation of the second gel (or crosslinked network), or the first gel (or crosslinked network) and the second gel (or crosslinked network) are crosslinked to one another simultaneously with formation of the first gel or crosslinked network and/or simultaneously with formation of the second gel or crosslinked network.

In some embodiments, the organic PCM comprises one or more fatty acids, one or more fatty alcohols, one or more alkyl esters of a fatty acid, one or more fatty sulfonates or phosphonates, one or more paraffins, or a combination thereof. Any organic PCM not inconsistent with the objectives of the present invention may be used. In some embodiments, for instance, a PCM comprises a fatty acid. Any fatty acid not inconsistent with the objectives of the present invention may be used. A fatty acid, in some embodiments, can have a C4 to C28 aliphatic hydrocarbon tail. Further, in some embodiments, the hydrocarbon tail is saturated. Alternatively, in other embodiments, the hydrocarbon tail is unsaturated. In some embodiments, the hydrocarbon tail can be branched or linear. Non-limiting examples of fatty acids suitable for use in some embodiments described herein include caprylic acid, capric acid, lauric acid, myristic acid, palmitic acid, stearic acid, arachidic acid, behenic acid, lignoceric acid, and cerotic acid. In some embodiments, a PCM described herein comprises a plurality of differing fatty acids.

In some embodiments, the organic PCM comprises an alkyl ester of a fatty acid. Any alkyl ester not inconsistent with the objectives of the present invention may be used. For instance, in some embodiments, an alkyl ester comprises a methyl, ethyl, propyl, or butyl ester of a fatty acid described herein. In other embodiments, an alkyl ester comprises a C2 to C6 ester alkyl backbone or a C6 to C12 ester alkyl backbone. In some embodiments, an alkyl ester comprises a C12 to C28 ester alkyl backbone. Further, in some embodiments, an oxidized fatty component described herein comprises a plurality of differing alkyl esters of fatty acids. Non-limiting examples of alkyl esters of fatty acids suitable for use in some embodiments described herein include methyl laurate, methyl myristate, methyl palmitate, methyl stearate, methyl palmitoleate, methyl oleate, methyl linoleate, methyl docosahexanoate, and methyl ecosapentanoate. In some embodiments, the corresponding ethyl, propyl, or butyl esters may also be used.

In some embodiments, the organic PCM comprises a fatty alcohol. Any fatty alcohol not inconsistent with the objectives of the present invention may be used. For instance, a fatty alcohol, in some embodiments, can have a C4 to C28 aliphatic hydrocarbon tail. Further, in some embodiments, the hydrocarbon tail is saturated. Alternatively, in other embodiments, the hydrocarbon tail is unsaturated. In some embodiments, the hydrocarbon tail can be branched or linear. Non-limiting examples of fatty alcohols suitable for use in some embodiments described herein include capryl alcohol, pelargonic alcohol, capric alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, arachidyl alcohol, heneicosyl alcohol, behenyl alcohol, lignoceryl alcohol, ceryl alcohol, and montanyl alcohol. In some embodiments, a PCM comprises a plurality of differing fatty alcohols.

In some embodiments, the organic PCM comprises a fatty sulfonate or phosphonate. Any fatty sulfonate or phosphonate not inconsistent with the objectives of the present invention may be used. In some embodiments, a PCM comprises a C4 to C28 alkyl sulfonate or phosphonate. In some embodiments, the organic PCM comprises a C4 to C28 alkenyl sulfonate or phosphonate. Further, in some embodiments, the organic PCM comprises a polyethylene glycol. Any polyethylene glycol not inconsistent with the objectives of the present invention may be used.

In some embodiments, the organic PCM comprises a paraffin. Any paraffin not inconsistent with the objectives of the present invention may be used. In some embodiments, a paraffin comprises an n-alkane. In some embodiments, a paraffin comprises a C10 to C60 alkane. In some embodiments, a paraffin comprises a C20 to C50 alkane or a C30 to C40 alkane. In some embodiments, a paraffin comprises a C10 to C30 alkane or a C14 to C28 alkane. Non-limiting examples of paraffins suitable for use in some embodiments described herein include n-dodecane, n-tridecane, n-tetradecane, n-pentadecane, n-hexadecane, n-heptadecane, n-octadecane, n-nonadecane, n-icosane, n-henicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, and/or mixtures thereof.

In some embodiments, a composition described herein comprises a plurality of organic PCMs. Any combination of organic PCMs not inconsistent with the objectives of the present invention may be used. In some embodiments, for example, the first PCM component comprises one or more fatty acids and one or more fatty alcohols. Moreover, in some embodiments, the first PCM component comprises a plurality of PCMs, the plurality of PCMs comprises between about 1 and about 99 weight percent fatty acid based on the total weight of the plurality of PCMs. In some embodiments, the plurality comprises between about 10 and about 90 weight percent, between about 20 and about 80 weight percent, between about 30 and about 70 weight percent, or between about 50 and about 90 weight percent fatty acid. In some embodiments, a plurality of PCMs comprises between about 1 and about 99 weight percent alkyl ester of a fatty acid. In some embodiments, the plurality comprises between about 10 and about 90 weight percent, between about 20 and about 80 weight percent, between about 30 and about 70 weight percent, or between about 50 and about 90 weight percent alkyl ester of a fatty acid. Further, in some embodiments, a plurality of PCMs comprises between about 1 and about 99 weight percent fatty alcohol. In some embodiments, the plurality comprises between about 10 and about 90 weight percent, between about 20 and about 80 weight percent, between about 30 and about 70 weight percent, between about 5 and about 50 weight percent, or between about 5 and about 25 weight percent fatty alcohol.

Further, in some embodiments, a plurality of organic PCMs is selected based on a desired viscosity and/or latent heat of the first PCM component. In some embodiments, the organic PCM or a plurality of organic PCMs is selected based on a desired phase transition temperature of the first PCM component. As understood by one having ordinary skill in the art, a phase transition temperature described herein (such as a phase transition temperature of “X” °C, where X may be -20° C., for example) may be represented as a normal distribution of temperatures centered on X°C. In addition, as understood by one having ordinary skill in the art, a PCM described herein can exhibit thermal hysteresis, such that the PCM exhibits a phase change temperature difference between the “forward” phase change and the “reverse” phase change (e.g., a solidification temperature that is different from the melting temperature). A phase transition temperature, in some embodiments, is between about -50° C. and about 100° C. at 1 atm or between about -40° C. and about 40° C. at 1 atm. In some embodiments, a phase transition temperature is between about -50° C. and about 0° C. at 1 atm or between about -20° C. and about 0° C. at 1 atm. In some embodiments, a phase transition temperature is between about 0° C. and about 70° C. at 1 atm or between about -4° C. and about 40° C. at 1 atm. In other embodiments, a phase transition temperature is between about 30° C. and about 50° C. at 1 atm or between about 35° C. and about 45° C. at 1 atm. In some embodiments, a phase transition temperature is between about 450° C. and about 550° C. at 1 atm, about 300° C. and about 550° C. at 1 atm, about 70° C. and about 100° C. at 1 atm, about 60° C. and about 80° C. at 1 atm, about 40° C. and about 60° C. at 1 atm, about 40° C. and about 50° C. at 1 atm, about 16° C. and about 23° C. at 1 atm, about 16° C. and about 18° C. at 1 atm, about 15° C. and about 20° C. at 1 atm, about 4° C. and about 10° C. at 1 atm, about 6° C. and about 8° C. at 1 atm, about -40° C. and about -10° C. at 1 atm, or between about -4° C. and about 40° C. at 1 atm. In other embodiments, a phase transition temperature is between about 30° C. and about 50° C. at 1 atm or between about 35° C. and about 45° C. at 1 atm.

In some embodiments, the inorganic PCM comprises a salt hydrate. Any salt hydrate not inconsistent with the objectives of the present invention may be used. Non-limiting examples of salt hydrates suitable for use in some embodiments described herein include KF • 4H₂O, Mn(NO₃)₂ • 6H₂O, CaCl₂ • 6H₂O, CaBr₂ • 6H₂O, Li(NO₃) • 6H₂O, Na₂SO₄ • 10H₂O, Na₂CO₃ • 10H₂O, Na₂HPO₄ • 12H₂O, Zn(NO₃)₂ • 6H₂O, Ca(NO₃)₂ • 3H₂O, Na(NO₃)₂ • 6H₂O, Zn(NO₃)₂ • 2H₂O, FeCl₃ • 2H₂O, Co(NO₃)₂ • 6H₂O, Ni(NO₃)₂ • 6H₂O, MnCl₂ • 4H₂O, CH₃COONa • 3H₂O, LiC₂H₃O₂ • 2H₂O, MgCl₂ • 4H₂O, NaOH • H₂O, Cd(NO₃)₂ • 4H₂O, Cd(NO₃)₂ • 1H₂O, Fe(NO₃)₂ • 6H₂O, NaAl(SO₄)₂ • 12H₂O, FeSO₄ • 7H₂O, Na₃PO₄ • 12H₂O, Na₂B₄O₇ • 10H₂O, Na₃PO₄ • 12H₂O, LiCH₃COO • 2H₂O, and/or mixtures thereof.

In some embodiments, a composition described herein comprises a plurality of inorganic PCMs. Any combination of inorganic PCMs not inconsistent with the objectives of the present invention may be used.

In some embodiments, a plurality of inorganic PCMs is selected based on a desired viscosity and/or latent heat of the second PCM component. In some embodiments, the inorganic PCM or a plurality of inorganic PCMs is selected based on a desired phase transition temperature of the second PCM component. A phase transition temperature, in some embodiments, is between about -50° C. and about 100° C. at 1 atm or between about -40° C. and about 40° C. at 1 atm. In some embodiments, a phase transition temperature is between about -50° C. and about 0° C. at 1 atm or between about -20° C. and about 0° C. at 1 atm. In some embodiments, a phase transition temperature is between about 0° C. and about 70° C. at 1 atm or between about -4° C. and about 40° C. at 1 atm. In other embodiments, a phase transition temperature is between about 30° C. and about 50° C. at 1 atm or between about 35° C. and about 45° C. at 1 atm. In some embodiments, a phase transition temperature is between about 450° C. and about 550° C. at 1 atm, about 300° C. and about 550° C. at 1 atm, about 70° C. and about 100° C. at 1 atm, about 60° C. and about 80° C. at 1 atm, about 40° C. and about 60° C. at 1 atm, about 40° C. and about 50° C. at 1 atm, about 16° C. and about 23° C. at 1 atm, about 16° C. and about 18° C. at 1 atm, about 15° C. and about 20° C. at 1 atm, about 4° C. and about 10° C. at 1 atm, about 6° C. and about 8° C. at 1 atm, about -40° C. and about -10° C. at 1 atm, or between about -4° C. and about 40° C. at 1 atm. In other embodiments, a phase transition temperature is between about 30° C. and about 50° C. at 1 atm or between about 35° C. and about 45° C. at 1 atm.

In some embodiments, a composition includes a first PCM component that has a phase transition temperature range between about 30° C. and about 50° C. at 1 atm or between about 35° C. and about 45° C. at 1 atm. In some embodiments, a phase transition temperature is between about 450° C. and about 550° C. at 1 atm, about 300° C. and about 550° C. at 1 atm, about 70° C. and about 100° C. at 1 atm, about 60° C. and about 80° C. at 1 atm, about 40° C. and about 60° C. at 1 atm, about 40° C. and about 50° C. at 1 atm, about 16° C. and about 23° C. at 1 atm, about 16° C. and about 18° C. at 1 atm, about 15° C. and about 20° C. at 1 atm, about 4° C. and about 10° C. at 1 atm, about 6° C. and about 8° C. at 1 atm, about -40° C. and about -10° C. at 1 atm, or between about -4° C. and about 40° C. at 1 atm, and a second PCM component that has a phase transition temperature range between about 30° C. and about 50° C. at 1 atm or between about 35° C. and about 45° C. at 1 atm. In some embodiments, a phase transition temperature is between about 450° C. and about 550° C. at 1 atm, about 300° C. and about 550° C. at 1 atm, about 70° C. and about 100° C. at 1 atm, about 60° C. and about 80° C. at 1 atm, about 40° C. and about 60° C. at 1 atm, about 40° C. and about 50° C. at 1 atm, about 16° C. and about 23° C. at 1 atm, about 16° C. and about 18° C. at 1 atm, about 15° C. and about 20° C. at 1 atm, about 4° C. and about 10° C. at 1 atm, about 6° C. and about 8° C. at 1 atm, about -40° C. and about -10° C. at 1 atm, or between about -4° C. and about 40° C. at 1 atm.

In some embodiments, the first PCM component has a phase transition temperature range that is distinct from the phase transition temperature range of the second PCM component such that the composition including the first and second PCM components have two distinct phase transition temperature ranges. In this way, instantaneous melting/freezing does not necessarily occur and significant volume changes and supercooling can occur. In some embodiments, the first PCM component has a phase transition temperature range that is similar to the phase transition temperature range of the second PCM component, which allows for concurrent transition of inorganic and organic compositions, eliminating substantial volume change and supercooling.

A composition described herein, in some embodiments, comprises a crosslinker linking the first PCM component to the second PCM component. In some embodiments, the crosslinker is chemically bonded to a PCM of the composition. Further, in some embodiments, a linker component chemically bonded to a PCM provides a non-polymeric material. In some embodiments, a linker component chemically bonded to a PCM provides an oligomeric material. In some embodiments, for example, a PCM is monofunctional. A monofunctional PCM, in some embodiments, can be chemically bonded to a linker component through a single functional group, such as a carboxyl or hydroxyl group. Further, in some embodiments, the crosslinker component is polyfunctional. A polyfunctional crosslinker, in some embodiments, can be chemically bonded to more than one PCM, including more than one monofunctional PCM. For example, in some embodiments, a bifunctional crosslinker (B) can be chemically bonded to two monofunctional PCMs (A) to provide an A-B-A trimer. In other embodiments, a bifunctional crosslinker is chemically bonded to one monofunctional PCM to provide an A-B dimer. Moreover, in some embodiments, the crosslinker described is also operative as a viscosity modifier described herein.

Further, the crosslinker can be chemically bonded to a PCM through any chemical bond not inconsistent with the objectives of the present invention. In some embodiments, for instance, a linker component is chemically bonded to a PCM through a covalent bond. In other embodiments, the crosslinker is chemically bonded to a PCM through an ionic bond or electrostatic bond. In some embodiments, the crosslinker is chemically bonded to a PCM through a hydrogen bond. In some embodiments, the crosslinker is chemically bonded to a PCM through a urethane bond. In other embodiments, the crosslinker is chemically bonded to a PCM through an amide bond. In some embodiments, the crosslinker is chemically bonded to a PCM through an ester bond.

In addition, the crosslinker described herein can comprise any chemical species not inconsistent with the objectives of the present invention. In some embodiments, for instance, the crosslinker comprises a functional group capable of forming a covalent bond with a functional group of a PCM described herein, such as a carboxyl group or a hydroxyl group. In some embodiments, the crosslinker comprises a polyol. In some embodiments, the crosslinker comprises a saccharide, including a monosaccharide, disaccharide, oligosaccharide, or polysaccharide. A polysaccharide, in some embodiments, comprises cellulose or a cellulose derivative. Further, in some embodiments, the crosslinker comprises a sugar alcohol, such as glycol, glycerol, erythritol, threitol, arabitol, xylitol, ribitol, mannitol, sorbitol, dulcitol, iditol, isomalt, maltitol, or lactitol.

In other embodiments, the crosslinker comprises an isocyanate. In some embodiments, a linker component comprises a diisocyanate, such as a methylene diphenyl diisocyanate (MDI), toluene diisocyanate (TDI), naphthalene diisocyanate (NDI), isophorone diisocyanate (IPDI), and/or hexamethylene diisocyanate (HDI). Non-limiting examples of diisocyanates suitable for use in some embodiments described herein include Lupranate® LP27, LP30, LP30D, M, MI, MS, M10, M20, M20S, M20FB, M20HB, M20SB, M70L, MM103, MP102, MS, R2500, R2500U, T80-Type 1, T80-Type 2, TF2115, 78, 81, 219, 223, 227, 230, 234, 245, 259, 265, 266, 273, 275, 278, 280, 281, 5010, 5020, 5030, 5040, 5050, 5060, 5070, 5080, 5090, 5100, 5110, 5140, 5143, and 8020, all commercially available from BASF. Other non-limiting examples of diisocyanates suitable for use in some embodiments described herein include Suprasec® 2004, 2029, 5025, 7316, 7507, 9150, 9561, 9577, 9582, 9600, 9603, 9608, 9612, 9610, 9612, 9615, and 9616 as well as Rubinate® 1209, 1234, 1670, 1790, 1920, 9040, 9234, 9236, 9271, 9272, 9465, and 9511, all commercially available from Huntsman. Other major producers of diisocyanates include Bayer, BorsodChem, Dow, Mitsui, Nippon Polyurethane Industry and Yantai Wanhua.

Further, in some embodiments, a composition described herein comprises a plurality of crosslinkers. Any combination of crosslinkers not inconsistent with the objectives of the present invention may be used. In some embodiments, a plurality of crosslinkers is selected based on a desired viscosity of a composition.

In addition, the crosslinker described herein can be present in a composition in any amount not inconsistent with the objectives of the present invention. In some embodiments, for instance, a composition comprises less than about 10 weight percent of the crosslinker based on the total weight of the composition. In some embodiments, a composition comprises less than about 5 weight percent, less than about 3 weight percent, less than about 2 weight percent, or less than about 1 weight percent of the crosslinker. In some embodiments, a composition comprises between about 1 weight percent and about 5 weight percent of the crosslinker or between about 1 weight percent about 8 weight percent of the crosslinker.

In some embodiments, the first PCM component includes a first linking component. In some embodiments, a first linker component is chemically bonded to the organic PCM of the first PCM component. Further, in some embodiments, the first linker component chemically bonded to a PCM provides a non-polymeric material. In some embodiments, the first linker component chemically bonded to a PCM provides an oligomeric material. In some embodiments, for example, a PCM is monofunctional. A monofunctional PCM, in some embodiments, can be chemically bonded to the first linker component through a single functional group, such as a carboxyl or hydroxyl group. Further, in some embodiments, the first linker component is polyfunctional. The polyfunctional linker component, in some embodiments, can be chemically bonded to more than one PCM, including more than one monofunctional PCM. For example, in some embodiments, a bifunctional linker component (B) can be chemically bonded to two monofunctional PCMs (A) to provide an A-B-A trimer. In other embodiments, a bifunctional linker component is chemically bonded to one monofunctional PCM to provide an A-B dimer. Moreover, in some embodiments, the first linker component described is also operative as a viscosity modifier described herein.

Further, the first linker component can be chemically bonded to a PCM through any chemical bond not inconsistent with the objectives of the present invention. In some embodiments, for instance, the first linker component is chemically bonded to a PCM through a covalent bond. In other embodiments, the first linker component is chemically bonded to a PCM through an ionic bond or electrostatic bond. In some embodiments, the first linker component is chemically bonded to a PCM through a hydrogen bond. In some embodiments, the first linker component is chemically bonded to a PCM through a urethane bond. In other embodiments, the first linker component is chemically bonded to a PCM through an amide bond. In some embodiments, the first linker component is chemically bonded to a PCM through an ester bond.

In addition, the first linker component described herein can comprise any chemical species not inconsistent with the objectives of the present invention. In some embodiments, for instance, the first linker component comprises a functional group capable of forming a covalent bond with a functional group of a PCM described herein, such as a carboxyl group or a hydroxyl group. In some embodiments, the first linker component comprises a polyol. In some embodiments, the first linker component comprises a saccharide, including a monosaccharide, disaccharide, oligosaccharide, or polysaccharide. A polysaccharide, in some embodiments, comprises cellulose or a cellulose derivative. Further, in some embodiments, the first linker component comprises a sugar alcohol, such as glycol, glycerol, erythritol, threitol, arabitol, xylitol, ribitol, mannitol, sorbitol, dulcitol, iditol, isomalt, maltitol, or lactitol.

In other embodiments, the first linker component comprises an isocyanate. In some embodiments, the first linker component comprises a diisocyanate, such as a methylene diphenyl diisocyanate (MDI), toluene diisocyanate (TDI), naphthalene diisocyanate (NDI), isophorone diisocyanate (IPDI), and/or hexamethylene diisocyanate (HDI). Non-limiting examples of diisocyanates suitable for use in some embodiments described herein include Lupranate® LP27, LP30, LP30D, M, MI, MS, M10, M20, M20S, M20FB, M20HB, M20SB, M70L, MM103, MP102, MS, R2500, R2500U, T80-Type 1, T80-Type 2, TF2115, 78, 81, 219, 223, 227, 230, 234, 245, 259, 265, 266, 273, 275, 278, 280, 281, 5010, 5020, 5030, 5040, 5050, 5060, 5070, 5080, 5090, 5100, 5110, 5140, 5143, and 8020, all commercially available from BASF. Other non-limiting examples of diisocyanates suitable for use in some embodiments described herein include Suprasec® 2004, 2029, 5025, 7316, 7507, 9150, 9561, 9577, 9582, 9600, 9603, 9608, 9612, 9610, 9612, 9615, and 9616 as well as Rubinate® 1209, 1234, 1670, 1790, 1920, 9040, 9234, 9236, 9271, 9272, 9465, and 9511, all commercially available from Huntsman. Other major producers of diisocyanates include Bayer, BorsodChem, Dow, Mitsui, Nippon Polyurethane Industry and Yantai Wanhua.

Further, in some embodiments, the first PCM component described herein comprises a plurality of linker components. Any combination of linker components not inconsistent with the objectives of the present invention may be used. In some embodiments, a plurality of linker components is selected based on a desired viscosity of a composition.

In addition, the first linker component described herein can be present in the first PCM component in any amount not inconsistent with the objectives of the present invention. In some embodiments, for instance, the first PCM component comprises less than about 10 weight percent of the first linker component based on the total weight of the first PCM component. In some embodiments, the first PCM component comprises less than about 5 weight percent, less than about 3 weight percent, less than about 2 weight percent, or less than about 1 weight percent of the first linker component. In some embodiments, the first PCM component comprises between about 1 weight percent and about 5 weight percent of the first linker component or between about 1 weight percent about 8 weight percent of the first linker component. Further, in some embodiments, the first PCM component comprises less of the first linker component than PCM. For example, in some embodiments, the ratio of PCM to the first linker component is greater than about 2:1, greater than about 5:1, greater than about 10:1, greater than about 20:1, or greater than about 40:1 by weight. In some embodiments, the ratio of PCM to the first linker component is between about 2:1 and about 50:1 or between about 5:1 and about 30:1.

In some embodiments, the second PCM component includes a second linking component. In some embodiments, a second linker component is chemically bonded to the organic PCM of the first PCM component. Further, in some embodiments, the second linker component chemically bonded to a PCM provides a non-polymeric material. In some embodiments, the second linker component chemically bonded to a PCM provides an oligomeric material. In some embodiments, for example, a PCM is monofunctional. A monofunctional PCM, in some embodiments, can be chemically bonded to the second linker component through a single functional group, such as a carboxyl or hydroxyl group. Further, in some embodiments, the second linker component is polyfunctional. The polyfunctional linker component, in some embodiments, can be chemically bonded to more than one PCM, including more than one monofunctional PCM. For example, in some embodiments, a bifunctional linker component (B) can be chemically bonded to two monofunctional PCMs (A) to provide an A-B-A trimer. In other embodiments, a bifunctional linker component is chemically bonded to one monofunctional PCM to provide an A-B dimer. Moreover, in some embodiments, the second linker component described is also operative as a viscosity modifier described herein.

Further, the second linker component can be chemically bonded to a PCM through any chemical bond not inconsistent with the objectives of the present invention. In some embodiments, for instance, the second linker component is chemically bonded to a PCM through a covalent bond. In other embodiments, the second linker component is chemically bonded to a PCM through an ionic bond or electrostatic bond. In some embodiments, the first linker component is chemically bonded to a PCM through a hydrogen bond. In some embodiments, the first linker component is chemically bonded to a PCM through a urethane bond. In other embodiments, the second linker component is chemically bonded to a PCM through an amide bond. In some embodiments, the second linker component is chemically bonded to a PCM through an ester bond.

In addition, the second linker component described herein can comprise any chemical species not inconsistent with the objectives of the present invention. In some embodiments, for instance, the first linker component comprises a functional group capable of forming a covalent bond with a functional group of a PCM described herein, such as a carboxyl group or a hydroxyl group. In some embodiments, the second linker component comprises a polyol. In some embodiments, the second linker component comprises a saccharide, including a monosaccharide, disaccharide, oligosaccharide, or polysaccharide. A polysaccharide, in some embodiments, comprises cellulose or a cellulose derivative. Further, in some embodiments, the second linker component comprises a sugar alcohol, such as glycol, glycerol, erythritol, threitol, arabitol, xylitol, ribitol, mannitol, sorbitol, dulcitol, iditol, isomalt, maltitol, or lactitol.

In other embodiments, the second linker component comprises an isocyanate. In some embodiments, the second linker component comprises a diisocyanate, such as a methylene diphenyl diisocyanate (MDI), toluene diisocyanate (TDI), naphthalene diisocyanate (NDI), isophorone diisocyanate (IPDI), and/or hexamethylene diisocyanate (HDI). Non-limiting examples of diisocyanates suitable for use in some embodiments described herein include Lupranate® LP27, LP30, LP30D, M, MI, MS, M10, M20, M20S, M20FB, M20HB, M20SB, M70L, MM103, MP102, MS, R2500, R2500U, T80-Type 1, T80-Type 2, TF2115, 78, 81, 219, 223, 227, 230, 234, 245, 259, 265, 266, 273, 275, 278, 280, 281, 5010, 5020, 5030, 5040, 5050, 5060, 5070, 5080, 5090, 5100, 5110, 5140, 5143, and 8020, all commercially available from BASF. Other non-limiting examples of diisocyanates suitable for use in some embodiments described herein include Suprasec® 2004, 2029, 5025, 7316, 7507, 9150, 9561, 9577, 9582, 9600, 9603, 9608, 9612, 9610, 9612, 9615, and 9616 as well as Rubinate® 1209, 1234, 1670, 1790, 1920, 9040, 9234, 9236, 9271, 9272, 9465, and 9511, all commercially available from Huntsman. Other major producers of diisocyanates include Bayer, BorsodChem, Dow, Mitsui, Nippon Polyurethane Industry and Yantai Wanhua.

Further, in some embodiments, the second PCM component described herein comprises a plurality of linker components. Any combination of linker components not inconsistent with the objectives of the present invention may be used. In some embodiments, a plurality of linker components is selected based on a desired viscosity of a composition.

In addition, the second linker component described herein can be present in the second PCM component in any amount not inconsistent with the objectives of the present invention. In some embodiments, for instance, the second PCM component comprises less than about 10 weight percent of the second linker component based on the total weight of the second PCM component. In some embodiments, the second PCM component comprises less than about 5 weight percent, less than about 3 weight percent, less than about 2 weight percent, or less than about 1 weight percent of the second linker component. In some embodiments, the second PCM component comprises between about 1 weight percent and about 5 weight percent of the second linker component or between about 1 weight percent about 8 weight percent of the second linker component. Further, in some embodiments, the second PCM component comprises less of the first linker component than PCM. For example, in some embodiments, the ratio of PCM to the second linker component is greater than about 2:1, greater than about 5:1, greater than about 10:1, greater than about 20:1, or greater than about 40:1 by weight. In some embodiments, the ratio of PCM to the second linker component is between about 2:1 and about 50:1 or between about 5:1 and about 30:1.

Compositions described herein also can comprise one or more additives, including viscosity-altering additives. An additive can comprise any material not inconsistent with the objectives of the present invention. In some embodiments, the first PCM component includes one or more additives. In some embodiments, the second PCM component includes one or more additives. In some embodiments, the composition outside the first and second PCM components includes one or more additives. In some embodiments, one or more additives can be added to the first PCM component, the second PCM component, the composition outside the first and second PCM components, or any combination thereof.

In some embodiments, for example, an additive comprises an ionic liquid. Any ionic liquid not inconsistent with the objectives of the present invention may be used. In some embodiments, an ionic liquid is imidazolium-based. In other embodiments, an ionic liquid is pyridinium-based. In some embodiments, an ionic liquid is choline-based. Further, in some embodiments, an ionic liquid comprises a sugar, sugar alcohol, or sugar derivative, such as glycol-choline, glycerol-choline, erythritol-choline, threitol-choline, arabitol-choline, xylitol-choline, ribitol-choline, mannitol-choline, sorbitol-choline, dulcitol-choline, iditol-choline, isomalt-choline, maltitol-choline, or lactitol-choline. Non-limiting examples of ionic liquids suitable for use in some embodiments described herein include 1-Allyl-3-methylimidazolium bis(trifluoromethylsulfonyl)imide, 1-Allyl-3-methylimidazolium bromide, 1-Allyl-3-methylimidazolium dicyanamide, 1-Allyl-3-methylimidazolium iodide, 1-Benzyl-3-methylimidazolium chloride, 1-Benzyl-3-methylimidazolium hexafluorophosphate, 1-Benzyl-3-methylimidazolium tetrafluoroborate, 1,3-Bis(3-cyanopropyl)imidazolium bis(trifluoromethylsulfonyl)imide, 1,3-Bis(3-cyanopropyl)imidazolium chloride, 1-Butyl-2,3-dimethylimidazolium hexafluorophosphate, 1-Butyl-2,3-dimethylimidazolium tetrafluoroborate, 4-(3-Butyl-1-imidazolio)-1-butanesulfonate, 1-Butyl-3-methylimidazolium acetate, 1-Butyl-3-methylimidazolium chloride, 1-Butyl-3-methylimidazolium dibutyl phosphate, 1-Butyl-3-methylimidazolium hexafluorophosphate, 1-Butyl-3-methylimidazolium nitrate, 1-Butyl-3-methylimidazolium octyl sulfate, 1-Butyl-3-methylimidazolium tetrachloroaluminate, 1-Butyl-3-methylimidazolium tetrafluoroborate, 1-Butyl-3-methylimidazolium thiocyanate, 1-Butyl-3-methylimidazolium tosylate, 1-Butyl-3-methylimidazolium trifluoroacetate, 1-Butyl-3-methylimidazolium trifluoromethanesulfonate, 1-(3-Cyanopropyl)-3-methylimidazolium bis(trifluoromethylsulfonyl)amide, 1-Decyl-3-methylimidazolium tetrafluoroborate, 1,3-Diethoxyimidazolium bis(trifluoromethylsulfonyl)imide, 1,3-Diethoxyimidazolium hexafluorophosphate, 1,3-Dihydroxyimidazolium bis(trifluoromethylsulfonyl)imide, 1,3-Dihydroxy-2-methylimidazolium bis(trifluoromethylsulfonyl)imide, 1,3-Dimethoxy-2-methylimidazolium hexafluorophosphate, 1-Dodecyl-3-methylimidazolium iodide, 1-Ethyl-2,3-dimethylimidazolium tetrafluoroborate, 1-Ethyl-3-methylimidazolium hexafluorophosphate, 1-Ethyl-3-methylimidazolium L-(+)-lactate, 1-Ethyl-3-methylimidazolium 1,1,2,2-tetrafluoroethanesulfonate, 1-Hexyl-3-methylimidazolium bis(trifluormethylsulfonyl)imide, 1-Hexyl-3-methylimidazolium chloride, 1-Hexyl-3-methylimidazolium hexafluorophosphate, 1-Methylimidazolium chloride, 1-Methyl-3-octylimidazolium chloride, 1-Methyl-3-octylimidazolium tetrafluoroborate, 1-Methyl-3-propylimidazolium iodide, 1-Methyl-3-(3,3,4,4,5,5,6,6,7,7,8,8,8-tridecafluorooctyl)imidazolium hexafluorophosphate, 1,2,3-Trimethylimidazolium methyl sulfate, 1-Butyl-4-methylpyridinium chloride, 1-Butyl-4-methylpyridinium hexafluorophosphate, 1-Butylpyridinium bromide, 1-(3-Cyanopropyl)pyridinium chloride, 1-Ethylpyridinium tetrafluoroborate, 3-Methyl-1-propylpyridinium bis(trifluormethylsulfonyl)imide, and Cholin acetate, all available commercially from Sigma-Aldrich.

In some embodiments, an additive comprises an aerogel. Any aerogel not inconsistent with the objectives of the present invention may be used. An aerogel, in some embodiments, comprises an organic composition such as agar. In some embodiments, an aerogel comprises carbon. In some embodiments, an aerogel comprises alumina. In some embodiments, an aerogel comprises silica, including fumed silica. Moreover, an aerogel comprising fumed silica, in some embodiments, comprises particles having a size from about 1 µm to about 10 mm. In some embodiments, the particles have a size from about 1 µm to about 100 µm, from about 1 µm to about 10 µm, or from about 5 µm to about 10 µm. Further, in some embodiments, an aerogel has high porosity. For instance, in some embodiments, an aerogel comprises over 90 percent air. In addition, in some embodiments, an aerogel comprises pores having a size between about 1 nm and about 100 nm. In some embodiments, the pores have a size between about 10 nm and about 100 nm or between about 20 nm and about 40 nm. Moreover, an aerogel described herein, in some embodiments, has a high surface area, such as a surface area of about 500 m²/g or more. In some embodiments, an aerogel has a surface area between about 500 m²/g and about 1000 m²/g or between about 600 m²/g and about 900 m²/g. In addition, in some embodiments, an aerogel has a low tap density. In some embodiments, for instance, an aerogel has a tap density less than about 500 kg/m³ or less than about 100 kg/m³. In some embodiments, an aerogel has a tap density between about 1 kg/m³ and about 200 kg/m³, between about 10 kg/m³ and about 100 kg/m³. Further, in some embodiments, an aerogel described herein has a low thermal conductivity. In some embodiments, an aerogel has a thermal conductivity less than about 50 mW/mK or less than about 20 mW/mK. In some embodiments, an aerogel has a thermal conductivity between about 1 mW/mK and about 20 mW/mK or between about 5 mW/mK and about 15 mW/mK. Moreover, in some embodiments, an aerogel has a hydrophobic surface. In addition, in some embodiments, an aerogel has a high oil absorption capacity (DBP). In some embodiments, an aerogel has an oil absorption capacity greater than about 100 g/100 g. In some embodiments, an aerogel has an oil absorption capacity greater than about 500 g/100 g. In some embodiments, an aerogel has an oil absorption capacity between about 100 g/100 g and about 1000 g/100 g, between about 300 g/100 g and about 800 g/100 g, or between about 400 g/100 g and about 600 g/100 g. Further, in some embodiments, an aerogel has a specific heat capacity between about 0.1 kJ/(kg K) and about 5 kJ/(kg K). In some embodiments, an aerogel has a specific heat capacity between about 0.5 kJ/(kg K) and about 1.5 kJ/(kg K).

In some embodiments, compositions described herein also can include a polymeric material. Any polymeric material not inconsistent with the objectives of the present invention may be used. In some embodiments, a polymeric material comprises an organic composition. For example, in some embodiments, a polymeric material comprises a polyolefin such as polyethylene or polypropylene, a polycarbonate, a polyester, or a polyurethane. In some embodiments, a polymeric material comprises polyvinyl alcohol (PVA). In some embodiments, a polymeric material comprises an acrylonitrile, including a polyacrylonitrile or acrylonitrile copolymer. An acrylonitrile copolymer, in some embodiments, comprises styrene-acrylonitrile (SAN), acrylonitrile styrene acrylate (ASA), acrylonitrile butadiene (NBR), and acrylonitrile butadiene styrene (ABS). In some embodiments, a composition comprises a particulate polymeric material, such as ABS grains.

In some embodiments, a polymeric material comprises a styrene block copolymer (SBC). A styrene block copolymer, in some embodiments, comprises a linear triblock copolymer. The linear triblock copolymer, in some embodiments, comprises an A-B-A structure, where the A blocks comprise polystyrene and the B block comprises an elastomer. In some embodiments, an SBC comprises between about 20 percent and about 40 percent polystyrene. In some embodiments, an SBC comprises between about 25 percent and about 35 percent polystyrene. Further, in some embodiments, an SBC can be maleated or unmaleated. Moreover, in some embodiments, an SBC has an average molecular weight greater than about 75,000. In some embodiments, an SBC has an average molecular weight greater than about 200,000. In some embodiments, an SBC has an average molecular weight between about 75,000 and about 1,000,000, between about 75,000 and about 500,000, or between about 100,000 and about 300,000. For reference purposes herein, molecular weight comprises weight average molecular weight. In addition, in some embodiments, an SBC has a specific gravity less than about 1. In some embodiments, an SBC has a Shore A hardness between about 50 and about 100. In some embodiments, an SBC has a Shore A hardness between about 50 and about 75 or between about 55 and about 70. Non-limiting examples of SBCs useful in some embodiments described herein include styrene-ethylene-butylene-styrene, styrene-ethylene-propylene-styrene, styrene-ethylene-ethylene/propylene-styrene, styrene-isobutylene-styrene, styrene-butadiene-styrene, styrene-isoprene-styrene, and combinations thereof. Commercially available SBCs useful in some embodiments described herein include SBCs provided by Kraton Polymers (Houston, Tex.), such as Kraton G1651HU, Kraton G1650, Kraton G1652, and Kraton G1654H.

In some embodiments, a polymeric material comprises a biopolymer. For instance, in some embodiments, a polymeric material comprises cellulose or a cellulosic material or cellulose derivative. In some embodiments, a polymeric material comprises hydroxymethyl cellulose (HMC), hydroxyethyl cellulose (HEC), hydroxypropyl cellulose (HPC), hydroxypropylmethyl cellulose (HPMC), hydroxypropyl methylcellulose phthalic ester (HPMCP), methyl cellulose (MC), ethyl cellulose (EC), carboxymethyl cellulose (CMC), and/or polyanionic cellulose (PAC). In some embodiments, a cellulosic material or cellulose derivative has a molecular weight between about 100,000 and about 2,000,000. In some embodiments, a cellulosic material or cellulosic derivative has a molecular weight between about 250,000 and about 1,500,000, between about 250,000 and about 450,000, between about 750,000 and about 950,000, or between about 1,000,000 and about 1,300,000. Further, in some embodiments, a polymeric material comprises chitosan. In some embodiments, the chitosan has a molecular weight between about 3000 and 20,000. Further, in some embodiments, the chitosan has a degree of deacetylation between about 50 percent and about 100 percent.

In some embodiments, an additive comprises an inorganic composition. For example, in some embodiments, an additive comprises a zeolite. Any zeolite not inconsistent with the objectives of the present invention may be used. In some embodiments, a zeolite comprises a natural zeolite. In other embodiments, a zeolite comprises an artificial zeolite. In some embodiments, a zeolite comprises a silicate and/or aluminosilicate. In some embodiments, a zeolite comprises a composition according to the formula M_{x/n} [(AlO₂)ₓ(SiO₂)_{y}].w H₂O, where n is the valence of cation M (e.g., Na⁺, K⁺, Ca²⁺, or Mg²⁺), w is the number of water molecules per unit cell, and x and y are the total number of tetrahedral atoms per unit cell. Non-limiting examples of zeolites suitable for use in some embodiments described herein include analcime ((K,Ca,Na)AlSi₂O₆.H₂O), chabazite ((Ca,Na₂,K₂,Mg)Al₂Si₄O₁₂.6H₂O), clinoptilolite ((Na,K,Ca)₂₋₃Al₃(Al, Si)₂Si₁₃O₃₆.12H₂O), heulandite ((Ca,Na)₂₋₃Al₃(Al,Si)₂Si₁₃O₃₆.12H₂O), natrolite (Na₂Al₂Si₃O₁₀.2H₂O), phillipsite ((Ca,Na₂,K₂)₃Al₆Si₁₀O₃₂. 12H₂O), and stilbite (NaCa₄(Si₂₇Al₉)O₇₂.28(H₂O)).

In some embodiments, an additive comprises a thermal conductivity modulator. Any thermal conductivity modulator not inconsistent with the objectives of the present invention may be used. In some embodiments, for instance, a thermal conductivity modulator comprises carbon, including graphitic carbon. In some embodiments, a thermal conductivity modulator comprises carbon black and/or carbon nanoparticles. Carbon nanoparticles, in some embodiments, comprise carbon nanotubes and/or fullerenes. In some embodiments, a thermal conductivity modulator comprises a graphitic matrix structure. In other embodiments, a thermal conductivity modulator comprises an ionic liquid. In some embodiments, a thermal conductivity modulator comprises a metal, including pure metals and alloys. Any metal not inconsistent with the objectives of the present invention may be used. In some embodiments, a metal comprises a transition metal, such as silver or copper. In some embodiments, a metal comprises an element from Group 13 or Group 14 of the periodic table. In some embodiments, a metal comprises aluminum. In some embodiments, a thermal conductivity modulator comprises a metallic filler, a metal matrix structure, a metal tube, a metal plate, and/or metal shavings. Further, in some embodiments, a thermal conductivity modulator comprises a metal oxide. Any metal oxide not inconsistent with the objectives of the present invention may be used. In some embodiments, a metal oxide comprises a transition metal oxide. In some embodiments, a metal oxide comprises alumina.

In some embodiments, an additive comprises an antimicrobial material. Any antimicrobial material not inconsistent with the objectives of the present invention may be used. An antimicrobial material, in some embodiments, comprises an inorganic composition, including metals and/or metal salts. In some embodiments, for example, an antimicrobial material comprises metallic copper, zinc, or silver or a salt of copper, zinc, or silver. Moreover, in some embodiments, an antimicrobial material comprising a metal can also provide thermal conductivity modulation. In other embodiments, an antimicrobial material comprises an organic composition, including natural and synthetic organic compositions. In some embodiments, an antimicrobial material comprises a β-lactam such as a penicillin or cephalosporin. In some embodiments, an antimicrobial material comprises a protein synthesis inhibitor such as neomycin. In some embodiments, an antimicrobial material comprises an organic acid, such as lactic acid, acetic acid, or citric acid. In some embodiments, an antimicrobial material comprises a quarternary ammonium species. A quarternary ammonium species, in some embodiments, comprises a long alkyl chain, such as an alkyl chain having a C8 to C28 backbone. In some embodiments, an antimicrobial material comprises one or more of benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, and domiphen bromide.

In some embodiments, an additive comprises a fire retardant. Any fire retardant not inconsistent with the objectives of the present invention may be used. In some embodiments, a fire retardant comprises a foam. Further, in some embodiments, a fire retardant can comprise an organic composition or an inorganic composition. In some embodiments, a fire retardant comprises tris(2-chloro-1-(chloromethyl)ethyl)phosphate. In some embodiments, a fire retardant comprises aluminum hydroxide and/or magnesium hydroxide. In some embodiments, a fire retardant comprises a zeolite, including a zeolite described herein.

In some embodiments, an additive comprises a catalyst. Any catalyst not inconsistent with the objectives of the present invention may be used. In some embodiments, a catalyst is selected based on the identity of one or more of a desired chemical bond, a solvent, a PCM, and a linker component. In some embodiments, a catalyst comprises a tertiary amine, such as triethylamine or triethanolamine. In other embodiments, a catalyst comprises an organometallic complex. In some embodiments, a catalyst comprises a metal complex comprising mercury, lead, tin, bismuth or zinc, including organometallic complexes. In some embodiments, a catalyst comprises a dibutyltin, such as dibutyltin laurate. Moreover, in some embodiments, a catalyst is provided in an amount less than about 0.1 weight percent. In some embodiments, a catalyst is provided in an amount between about 0.001 and about 0.1 weight percent.

In some embodiments, an additive comprises a nucleating agent. A nucleating agent, in some embodiments, can help avoid subcooling, particularly for PCMs comprising finely distributed phases, such as fatty alcohols, paraffinic alcohols, amines, and paraffins. Any nucleating agent not inconsistent with the objectives of the present disclosure may be used.

Moreover, a composition described herein, in some embodiments, comprises a plurality of additives. A composition can comprise any combination of additives described herein not inconsistent with the objectives of the present invention. For instance, in some embodiments, a composition comprises an ionic liquid and an aerogel or an ionic liquid and a polymeric material. In some embodiments, a composition comprises one or more ionic liquids, one or more aerogels, one or more polymeric materials, one or more zeolites, one or more thermal conductivity modulators, one or more antimicrobial materials, one or more fire retardants, and/or one or more catalysts.

Further, one or more additives described herein can be present in a composition in any amount not inconsistent with the objectives of the present invention. In some embodiments, for instance, a composition described herein comprises less than about 10 weight percent additive. In some embodiments, a composition comprises less than about 5 weight percent, less than about 3 weight percent, less than about 2 weight percent, or less than about 1 weight percent additive. In some embodiments, a composition comprises between about 1 weight percent and about 5 weight percent additive. Moreover, in some embodiments, the amount of additive present in a composition is selected based on one or more of a desired solid-to-gel transition temperature, a desired viscosity, and a desired latent heat of the composition.

In addition, a composition described herein, in some embodiments, exhibits desirable latent heat storage properties. In some embodiments, for instance, a composition described herein has a latent heat of at least about 100 J/g. In some embodiments, a composition has a latent heat of at least about 150 J/g. In some embodiments, a composition has a latent heat of at least about 180 J/g. In some embodiments, a composition has a latent heat of at least about 200 J/g. In some embodiments, a composition has a latent heat of at least about 220 J/g, at least about 230 J/g, or at least about 250 J/g. In some embodiments, a composition has a latent heat between about 100 J/g and about 300 J/g. In some embodiments, a composition has a latent heat between about 150 J/g and about 250 J/g, between about 150 J/g and about 220 J/g, between about 150 J/g and about 200 J/g, between about 180 J/g and about 250 J/g, or between about 180 J/g and about 220 J/g. Further, the latent heat of a composition described herein is associated with a transition between two condensed phases or states of the composition, such as a transition between a solid phase and a liquid phase, between a solid phase and a mesophase, or between two solid states. A mesophase, in some embodiments, comprises a phase intermediate between a solid phase and a liquid phase. In addition, it is contemplated herein that, in some embodiments, a composition may have more than one latent heat associated with a transition between two condensed phases or states, such as a first latent heat associated with a crystalline solid-amorphous solid transition and a second latent heat associated with a solid-liquid transition. In some embodiments comprising a composition having more than one latent heat associated with a transition between two condensed phases, one of the latent heats has a value described hereinabove. In other embodiments, a plurality or all of the latent heats have a value described hereinabove.

In some embodiments, a composition described herein includes the first PCM component in an amount of 30-70 weight percent (wt. %), based on the total weight of the composition. In some embodiments, a composition described herein includes the second PCM component in an amount of 30-70 weight percent (wt. %), based on the total weight of the composition. In some embodiments, a composition described herein includes the first PCM component in an amount of 30-70 weight percent (wt. %) and the second PCM component in an amount of 30-70 weight percent (wt. %), based on the total weight of the composition

Further, in some embodiments, a composition described herein exhibits other desirable properties for latent heat storage applications. For example, in some embodiments, a composition is non-flammable or substantially non-flammable. For reference purposes herein, a non-flammable or substantially non-flammable composition has a rating of A1, A2, or B1 when measured according to DIN 4102. Moreover, in some embodiments, a composition described herein has a viscosity between about 200 cP and about 20,000 cP, between about 200 cP and about 10,000 cP, between about 1000 cP and about 15,000 cP, or between about 1000 cP and about 5000 cP measured according to ASTM standard D2983. In some embodiments, a composition has a viscosity between about 200 cP and about 50,000 cP at a temperature between about 20° C. and about 70° C. at 1 atm. In some embodiments, a composition has a viscosity between about 200 cP and about 25,000 cP, between about 200 cP and about 10,000 cP, or between about 1000 cP and about 5000 cP at a temperature between about 20° C. and about 70° C. at 1 atm. In some embodiments, the composition has a dynamic viscosity of greater than or equal to 300,000 cP at 20° C. and 1 atm. In some embodiments, the first PCM component and the second PCM component have a dynamic viscosity of greater than or equal to 300,000 cP at 20° C. and 1 atm. In some embodiments, a composition does not readily flow without the application of an external force or pressure, permitting the use of the composition in various applications requiring little or no flow. In some embodiments, the PCM is self-supporting or non-encapsulated. Therefore, in some embodiments, compositions described herein can be used in various construction and engineering applications without the need for microencapsulation. In some embodiments, the PCM is microencapsulated.

Moreover, in some embodiments, a composition has a viscosity between about 5000 cP and about 20,000 cP at a temperature between about -40° C. and about 40° C. at 1 atm or between about -30° C. and about 30° C. at 1 atm. In some embodiments, a composition has a viscosity between about 5000 cP and about 20,000 cP at a temperature between about -50° C. and about 0° C. at 1 atm or between about -20° C. and about 0° C. at 1 atm. In other embodiments, a composition has a viscosity between about 5000 cP and about 20,000 cP at a temperature between about 30° C. and about 50° C. at 1 atm or between about 35° C. and about 45° C. at 1 atm. Therefore, in some embodiments, a composition described herein can exhibit desirable properties in hot and/or cold environments.

Without intending to being bound to any particular theory, the compositions described herein do not suffer from the disadvantages associated with conventional PCM compositions. That is, some compositions including salt hydrates may suffer from relatively high volume expansion, some compositions including organic PCMs may suffer from relatively low thermal conductivity and density, and some compositions including inorganic or organic PCMs may suffer from self-shielding. Compositions described herein, in certain instances, can advantageously control the size and speed of crystallization with very little volume change. In some embodiments, molecular gelling of the inorganic and organic PCMs of the compositions can control the size and speed of crystallization with very little volume change. In some embodiments, by incorporating nucleating agents that are also PCMs, sub-cooling effects can be controlled or avoided, and incongruent melting and freezing temperatures during transitions can be ensured, and phase segregation can be avoided.

### II. Methods of Making a Composition Comprising Phase Change Materials

Methods of making a composition are also disclosed herein. Compositions made in such methods can be any composition(s) consistent with the description provided in Section I herein above. In some embodiments, a method of making a composition comprises providing a first PCM component, providing a second PCM component, providing a crosslinker, and combining the first PCM component and the second PCM component with the crosslinker.

In some embodiments, providing a first PCM component includes forming a gel. In some embodiments, forming a gel comprises partially encapsulating a PCM in a linker component. Moreover, in some embodiments, forming a gel does not comprise providing water. For example, in some embodiments, forming a gel comprises providing a cellulosic material or cellulose derivative but does not comprise providing water. In other embodiments, forming a gel comprises forming one or more chemical bonds between a PCM and a linker component. The one or more chemical bonds can comprise any chemical bond between a PCM and linker component described hereinabove in Section I, including a urethane bond, amide bond, or ester bond. In addition, in some embodiments, forming one or more chemical bonds comprises providing a catalyst. Any catalyst not inconsistent with the objectives of the present invention may be used. In some embodiments, a catalyst is selected based on the identity of one or more of a desired chemical bond, a solvent, a PCM, and a linker component. In some embodiments, a catalyst comprises a tertiary amine, such as triethylamine or triethanolamine. In other embodiments, a catalyst comprises an organometallic complex. In some embodiments, a catalyst comprises a metal complex comprising mercury, lead, tin, bismuth or zinc, including organometallic complexes. In some embodiments, a catalyst comprises a dibutyltin, such as dibutyltin laurate. Moreover, in some embodiments, a catalyst is provided in an amount less than about 0.1 weight percent. In some embodiments, a catalyst is provided in an amount between about 0.001 and about 0.1 weight percent.

The first PCM component, in some embodiments, can comprise a first PCM component as described hereinabove in Section I. Further, in some embodiments, a first PCM component can comprise any component and/or have any property of a composition described hereinabove in Section I. For example, in some embodiments, the first PCM component is non-flammable or substantially non-flammable. In some embodiments, a first PCM component made by a method described herein has a viscosity between about 5000 cP and about 20,000 cP and/or has a condensed phase latent heat between about 100 J/g and about 300 J/g. In some embodiments, a composition made by a method described herein is free or substantially free of water.

Further, in some embodiments, forming a gel comprises increasing the viscosity of the first mixture. In some embodiments, forming a gel comprises increasing the viscosity of the first mixture from below about 100 centipoise (cP) to above about 100 cP when measured according to ASTM standard D2983. In some embodiments, forming a gel comprises increasing the viscosity of the first mixture from below about 200 cP to above about 200 cP when measured according to ASTM standard D2983. In some embodiments, forming a gel comprises increasing the viscosity of the first mixture from below about 200 cP to between about 200 cP and about 25,000 cP, between about 200 cP and about 10,000 cP, between about 1000 cP and about 15,000 cP, or between about 1000 cP and about 5000 cP.

In some embodiments, providing a second PCM component includes forming a gel. In some embodiments, forming a gel comprises partially encapsulating a PCM in a linker component. Moreover, in some embodiments, forming a gel does not comprise providing water. For example, in some embodiments, forming a gel comprises providing a cellulosic material or cellulose derivative but does not comprise providing water. In other embodiments, forming a gel comprises forming one or more chemical bonds between a PCM and a linker component. The one or more chemical bonds can comprise any chemical bond between a PCM and linker component described hereinabove in Section I, including a urethane bond, amide bond, or ester bond. In addition, in some embodiments, forming one or more chemical bonds comprises providing a catalyst. Any catalyst not inconsistent with the objectives of the present invention may be used. In some embodiments, a catalyst is selected based on the identity of one or more of a desired chemical bond, a solvent, a PCM, and a linker component. In some embodiments, a catalyst comprises a tertiary amine, such as triethylamine or triethanolamine. In other embodiments, a catalyst comprises an organometallic complex. In some embodiments, a catalyst comprises a metal complex comprising mercury, lead, tin, bismuth or zinc, including organometallic complexes. In some embodiments, a catalyst comprises a dibutyltin, such as dibutyltin laurate. Moreover, in some embodiments, a catalyst is provided in an amount less than about 0.1 weight percent. In some embodiments, a catalyst is provided in an amount between about 0.001 and about 0.1 weight percent.

The second PCM component, in some embodiments, can comprise a second component described hereinabove in Section I. Further, in some embodiments, a second PCM component can comprise any component and/or have any property of a composition described hereinabove in Section I. For example, in some embodiments, the second PCM component is non-flammable or substantially non-flammable. In some embodiments, a second PCM component made by a method described herein has a viscosity between about 5000 cP and about 20,000 cP and/or has a condensed phase latent heat between about 100 J/g and about 300 J/g. In some embodiments, a composition made by a method described herein is free or substantially free of water.

In some embodiments, the method includes providing a first PCM component that includes combining an organic PCM with a first linker component to provide a first mixture, providing a second PCM component that includes combining an inorganic PCM with a second linker component to provide a second mixture, providing a crosslinker, and combining the first mixture with the second mixture with the crosslinker. In some embodiments, the first linker component or the second linker component comprises a polyfunctional isocyanate. In some embodiments, the first linker component comprises a first polyfunctional isocyanate and the second linker component comprises a second polyfunctional isocyanate. Further, in some embodiments, the polyfunctional monomer comprises a polyol.

In some embodiments, combining a PCM with a first linker component comprises forming a chemical bond between the PCM and the first linker component. In some embodiments, the PCM is chemically bonded to the first linker component to provide a latent heat storage material. The latent heat storage material, in some embodiments, is non-polymeric. In some embodiments, the PCM is chemically bonded to the first linker component to provide an oligomeric latent heat storage material. For example, in some embodiments, a PCM comprises a monofunctional chemical species, such as a fatty alcohol, fatty acid, or alkyl ester of a fatty acid. In some embodiments, a first linker component comprises a polyfunctional chemical species, such as a polyfunctional isocyanate. A monofunctional chemical species of a PCM, in some embodiments, can be chemically bonded to a first linker component through a single functional group of the monofunctional chemical species, such as a carboxyl or hydroxyl group. Further, a polyfunctional chemical species of a first linker component, in some embodiments, can be chemically bonded to more than one chemical species of a PCM, including more than one monofunctional chemical species. For example, in some embodiments, a bifunctional first linker component (B) can be chemically bonded to two monofunctional PCMs (A) to provide an A-B-A trimer. In other embodiments, a bifunctional first linker component is chemically bonded to one monofunctional PCM to provide an A-B dimer.

In some embodiments, combining an inorganic PCM with a second linker component comprises forming a chemical bond between the PCM and the second linker component. In some embodiments, the PCM is chemically bonded to the second linker component to provide a latent heat storage material. The latent heat storage material, in some embodiments, is non-polymeric. In some embodiments, the PCM is chemically bonded to the second linker component to provide an oligomeric latent heat storage material. For example, in some embodiments, a PCM comprises a monofunctional chemical species. In some embodiments, a second linker component comprises a polyfunctional chemical species, such as a polyfunctional isocyanate. A monofunctional chemical species of a PCM, in some embodiments, can be chemically bonded to a second linker component through a single functional group of the monofunctional chemical species, such as a carboxyl or hydroxyl group. Further, a polyfunctional chemical species of a second linker component, in some embodiments, can be chemically bonded to more than one chemical species of a PCM, including more than one monofunctional chemical species. For example, in some embodiments, a bifunctional second linker component (B) can be chemically bonded to two monofunctional PCMs (A) to provide an A-B-A trimer. In other embodiments, a bifunctional first linker component is chemically bonded to one monofunctional PCM to provide an A-B dimer.

In addition, in some embodiments, combining an organic PCM with a first linker component to provide a first mixture comprises forming a gel (or a crosslinked network). The gel comprises the PCM and the first linker component. Further, in some embodiments, a gel is not formed from a dispersion of a solid phase with a liquid phase, such as a colloid. In addition, in some embodiments, a gel does not comprise a continuous liquid phase. Moreover, in some embodiments, a gel does not comprise water or is substantially free of water. For reference purposes herein, a substance that is substantially free of water comprises less than about 10 weight percent, less than about 5 weight percent, less than about 1 weight percent, or less than about 0.1 weight percent water, based on the total weight of the substance. A gel, in some embodiments, comprises a mesophase intermediate between a solid phase and a liquid phase.

Further, in some embodiments, forming a gel comprises increasing the viscosity of the first mixture. In some embodiments, forming a gel comprises increasing the viscosity of the first mixture from below about 100 centipoise (cP) to above about 100 cP when measured according to ASTM standard D2983. In some embodiments, forming a gel comprises increasing the viscosity of the first mixture from below about 200 cP to above about 200 cP when measured according to ASTM standard D2983. In some embodiments, forming a gel comprises increasing the viscosity of the first mixture from below about 200 cP to between about 200 cP and about 25,000 cP, between about 200 cP and about 10,000 cP, between about 1000 cP and about 15,000 cP, or between about 1000 cP and about 5000 cP.

In addition, in some embodiments, combining an inorganic PCM with a second linker component comprises forming a gel (or a crosslinked network). The gel comprises the inorganic PCM and the second linker component. Further, in some embodiments, a gel is not formed from a dispersion of a solid phase with a liquid phase, such as a colloid. In addition, in some embodiments, a gel does not comprise a continuous liquid phase. Moreover, in some embodiments, a gel does not comprise water or is substantially free of water. For reference purposes herein, a substance that is substantially free of water comprises less than about 10 weight percent, less than about 5 weight percent, less than about 1 weight percent, or less than about 0.1 weight percent water, based on the total weight of the substance. A gel, in some embodiments, comprises a mesophase intermediate between a solid phase and a liquid phase.

Further, in some embodiments, forming a gel comprises increasing the viscosity of the second mixture. In some embodiments, forming a gel comprises increasing the viscosity of the second mixture from below about 100 centipoise (cP) to above about 100 cP when measured according to ASTM standard D2983. In some embodiments, forming a gel comprises increasing the viscosity of the second mixture from below about 200 cP to above about 200 cP when measured according to ASTM standard D2983. In some embodiments, forming a gel comprises increasing the viscosity of the second mixture from below about 200 cP to between about 200 cP and about 25,000 cP, between about 200 cP and about 10,000 cP, between about 1000 cP and about 15,000 cP, or between about 1000 cP and about 5000 cP.

Moreover, in some embodiments described herein, combining a first mixture with a second mixture is carried out after forming a gel in the first mixture and/or forming a gel in the second mixture. Combining the first mixture with the second mixture after forming a gel in the first mixture and/or forming a gel in the second mixture, in some embodiments, permits non-competitive thickening of the first and second mixtures. In some embodiments, the first mixture is a gel and the second mixture is a pre-gel (or pre-crosslinked network) mixture when combining the first and second mixtures. In some embodiments, the first mixture is a pre-gel (or pre-crosslinked network) mixture and the second mixture is a gel when combining the first and second mixtures. In some embodiments, the first mixture is a gel and the second mixture is a gel when combining the first and second mixtures. In some embodiments, the first mixture is a pre-gel (or pre-crosslinked) mixture and the second mixture is also a pre-gel (or pre-crosslinked network) mixture when combining the first and second mixtures. In some embodiments, the first PCM component forms a first gel (or crosslinked network), the second PCM component forms a second gel (or crosslinked network) and the first gel (or crosslinked network) and the second gel (or crosslinked network) are crosslinked to one another after formation of the first gel (or crosslinked network) and/or after formation of the second gel (or crosslinked network), or the first gel (or crosslinked network) and the second gel (or crosslinked network) are crosslinked to one another simultaneously with formation of the first gel or crosslinked network and/or simultaneously with formation of the second gel or crosslinked network. In some embodiments, for example, the first mixture has a viscosity between about 200 cP and about 25,000 cP measured according to ASTM standard D2983 when combined with the second mixture.

In some embodiments, the first mixture has a viscosity between about 200 cP and about 10,000 cP, between about 1000 cP and about 15,000 cP, or between about 1000 cP and about 5000 cP when combined with the second mixture. However, in some embodiments described herein, combining a first mixture with a second mixture is carried out before substantial polymerization has occurred in the second mixture. Substantial polymerization, for reference purposes herein, comprises at least about 30 percent polymerization or at least about 40 percent polymerization, based on the amount of available monomer. In some embodiments, polymerization in the second mixture is indicated by a temperature increase of the second mixture. In some embodiments, combining a first mixture with a second mixture is carried out soon after a temperature increase is observed in the second mixture, such as within about 5 minutes or within about 1 minute of a temperature increase between about 5° C. and about 15° C.

In addition, in some embodiments, combining a first mixture with a second mixture comprises cross-linking one or more components of the first mixture with one or more components of the second mixture using the crosslinker. For example, in some embodiments, a gel of the first mixture is cross-linked with a gel of the second mixture.

The first and second mixtures can be combined in any manner not inconsistent with the objectives of the present invention. For example, in some embodiments, combining is carried out using a line addition process using one or more lines. In some embodiments, combining comprises mixing or stirring. Mixing or stirring can be carried out at any temperature not inconsistent with the objectives of the present invention. In some embodiments, mixing or stirring is carried out at a temperature greater than room temperature. In some embodiments, mixing or stirring is carried out at a temperature greater than a state or phase transition temperature of one or more components of the first and/or second mixture, such as a melting point. Moreover, mixing or stirring can be carried out for any duration not inconsistent with the objectives of the present invention. In some embodiments, for instance, mixing or stirring is carried out for less than about 60 minutes, less than about 30 minutes, or less than about 10 minutes. In some embodiments, mixing or stirring is carried out for a duration between about 1 minute and about 60 minutes, between about 10 minutes and about 50 minutes, or between about 20 minutes and about 40 minutes. Further, in some embodiments, the temperature and duration of mixing or stirring is selected based on a desired property of a gel (or crosslinked network) and/or the identity or reactivity of one or more components of the first mixture and/or second mixture.

Moreover, the first and second mixtures can be combined in any ratio not inconsistent with the objectives of the present invention. In some embodiments, for instance, the weight ratio of the first mixture to the second mixture is between about 1:100 and about 2:1. In some embodiments, the weight ratio of the first mixture to the second mixture is between about 1:50 and about 1:1. In some embodiments, the weight ratio of the first mixture to the second mixture is between about 1:20 and about 1:1, between about 1:10 and about 1:1, between about 1:5 and about 1:1, or between about 1:5 and about 2:1. In some embodiments, the first mixture is present in an amount of 30-70% based on the total weight of the composition and the second mixture is present in an amount of 30-70% based on the total weight of the composition.

In addition, in some embodiments of methods described herein, a first mixture is free or substantially free of water. In some embodiments, a second mixture is free or substantially free of water. Moreover, in some embodiments, a first mixture and a second mixture are both free or substantially free of water, including when the first mixture and the second mixture are combined.

A method described herein, in some embodiments, further comprises providing a catalyst. Providing a catalyst, in some embodiments, comprises adding a catalyst to the first mixture. In other embodiments, providing a catalyst comprises adding a catalyst to the second mixture. In some embodiments, providing a catalyst comprises adding a first catalyst to the first mixture and adding a second catalyst to the second mixture. Further, in some embodiments, providing a catalyst comprises adding a catalyst to the combination of the first and second mixtures. Adding a catalyst to a mixture or combination of mixtures described herein, in some embodiments, facilitates additional reaction between one or more components of the mixture or combination of mixtures. For example, in some embodiments, adding a catalyst facilitates additional polymerization, gelling, and/or cross-linking. Further, in some embodiments, adding a catalyst to the first and/or second mixture prior to combining the first and second mixtures provides separate mixtures having desired viscosities, including a viscosity corresponding to partial polymerization and/or gelling.

A catalyst can be provided in any manner not inconsistent with the objectives of the present invention. In some embodiments, for instance, providing a catalyst comprises providing a catalyst powder. Moreover, in some embodiments, a catalyst is provided in an amount less than about 0.1 weight percent of the mixture or combination of mixtures to which the catalyst is added. In some embodiments, a catalyst is provided in an amount between about 0.001 and about 0.1 weight percent.

Further, any catalyst not inconsistent with the objectives of the present invention may be used. In some embodiments, a catalyst is selected based on a desired chemical bond and/or reaction rate. For example, in some embodiments, a catalyst comprises a urethane catalyst. In some embodiments, a catalyst comprises a tertiary amine, such as triethylamine or triethanolamine. In other embodiments, a catalyst comprises an organometallic complex. In some embodiments, a catalyst comprises a metal complex comprising mercury, lead, tin, bismuth or zinc, including organometallic complexes. In some embodiments, a catalyst comprises a dibutyltin, such as dibutyltin laurate.

In addition, a method described herein, in some embodiments, further comprises providing a blowing agent. A blowing agent can be provided in any manner not inconsistent with the objectives of the present invention. In some embodiments, a blowing agent is provided as a liquid. In some embodiments, a blowing agent is provided as a gas. Moreover, in some embodiments, a blowing agent is provided in an amount less than about 0.1 weight percent of the combination of the first and second mixtures. In some embodiments, a blowing agent is provided in an amount between about 0.001 and about 0.1 weight percent. Further, any blowing agent not inconsistent with the objectives of the present invention may be used. In some embodiments, for instance, a blowing agent comprises water. In some embodiments, a blowing agent comprises a halocarbon. In some embodiments, a blowing agent comprises a hydrocarbon. In some embodiments, a blowing agent comprises carbon dioxide.

Methods described herein, in some embodiments, further comprise providing an aqueous polymeric material. An aqueous polymeric material can be provided in any manner not inconsistent with the objectives of the present invention. In some embodiments, providing an aqueous polymeric material comprises adding the aqueous polymeric material to the combination of the first and second mixtures. Further, in some embodiments, an aqueous polymeric material is added to the combination of the first and second mixtures after a catalyst is added to the first mixture, second mixture, and/or the combination of the first and second mixtures. Moreover, an aqueous polymeric material described herein can be provided in any amount not inconsistent with the objectives of the present invention. In some embodiments, for instance, an aqueous polymeric material is provided in an amount less than about 1 weight percent or less than about 0.1 weight percent of the combination of the first and second mixtures. In some embodiments, an aqueous polymeric material is provided in an amount between about 0.1 weight percent and about 1 weight percent or between about 0.001 and about 0.1 weight percent.

Further, any aqueous polymeric material not inconsistent with the objectives of the present invention may be used. In some embodiments, an aqueous polymeric material comprises an organic polymer or biopolymer dispersed in water. In some embodiments, the polymer is at least partially water soluble. In other embodiments, the polymer is suspended in water. Any organic polymer or biopolymer not inconsistent with the objectives of the present invention may be used. For instance, in some embodiments, a polymer comprises cellulose or a cellulosic material or cellulose derivative. In some embodiments, a polymer comprises hydroxymethyl cellulose (HMC), hydroxyethyl cellulose (HEC), hydroxypropyl cellulose (HPC), hydroxypropylmethyl cellulose (HPMC), hydroxypropyl methylcellulose phthalic ester (HPMCP), methyl cellulose (MC), ethyl cellulose (EC), carboxymethyl cellulose (CMC), and/or polyanionic cellulose (PAC). In some embodiments, a cellulosic material or cellulose derivative has a molecular weight between about 100,000 and about 2,000,000. In some embodiments, a cellulosic material or cellulosic derivative has a molecular weight between about 250,000 and about 1,500,000, between about 250,000 and about 450,000, between about 750,000 and about 950,000, or between about 1,000,000 and about 1,300,000. Further, in some embodiments, a polymer comprises chitosan. In some embodiments, the chitosan has a molecular weight between about 3000 and about 20,000. Moreover, in some embodiments, the chitosan has a degree of deacetylation between about 50 percent and about 100 percent. In addition, in some embodiments, an aqueous polymeric material described herein comprises less than about 10 weight percent polymer. In some embodiments, an aqueous polymeric material comprises less than about 5 weight percent polymer. In some embodiments, an aqueous polymeric material comprises between about 1 weight percent and about 10 weight percent or between about 1 weight percent and about 5 weight percent polymer. The balance of the aqueous polymeric material, in some embodiments, comprises water or consists essentially of water.

Methods described herein, in some embodiments, further comprise providing one or more additives. Providing one or more additives can be carried out in any manner not inconsistent with the objectives of the present invention. In some embodiments, one or more additives are added to the first mixture prior to combining the first mixture with the second mixture. In some embodiments, one or more additives are added to the second mixture prior to combining the first mixture with the second mixture. In some embodiments, one or more additives are added to the combination of the first and second mixtures. Moreover, an additive described herein can be provided in any amount not inconsistent with the objectives of the present invention. In some embodiments, for instance, an additive is provided in an amount less than about 10 weight percent, less than about 5 weight percent, less than about 3 weight percent, less than about 2 weight percent or less than about 1 weight percent of the mixture or combination of mixtures to which the additive is added. In some embodiments, an additive is provided in an amount between about 1 weight percent and about 10 weight percent or between about 1 weight percent and about 5 weight percent.

Further, any additive not inconsistent with the objectives of the present invention may be used. For example, any additive described hereinabove in Section I can be provided.

### III. Thermal Energy Storage and Management Systems

Thermal energy storage and/or management systems are also described herein. In some embodiments, a thermal energy storage system described herein comprises a container, a heat exchanger disposed within the container, and a PCM disposed within the container, wherein the heat exchanger comprises an inlet pipe or header, an outlet pipe or header, and a number n of thermal transfer or heat exchange plates in fluid communication with the inlet pipe and the outlet pipe such that a fluid flowing from the inlet pipe and to the outlet pipe flows through the plates in between the inlet pipe and the outlet pipe, wherein the PCM is in thermal contact with the plates, and wherein the number n is at least 2. In some cases, the number n is at least 5, at least 10, at least 20, or at least 50. In some instance, the number n is between 2 and 500, between 2 and 250, between 2 and 100, between 5 and 500, between 5 and 100, between 10 and 200, between 10 and 100, between 10 and 40, between 20 and 200, or between 20 and 100. However, the number of plates is not particularly limited and can be chosen based on the overall dimensions of the container, the spacing between plates, the amount of PCM, and/or the desired latent heat capacity of the system. Moreover, as described above, it is to be understood that fluid generally enters the heat exchanger apparatus through a “proximal” end of the inlet pipe and generally exits the heat exchange apparatus through a “distal” end of the outlet pipe or (in some cases) through a distal end of the inlet pipe. Additionally, in some instances, a fluid flowing into the inlet pipe and out of the outlet pipe flows through at least a portion of the plates or through some of the plates after flowing into the inlet pipe but before flowing out of the outlet pipe. Further details regarding the configuration, operation, and use of systems described herein is provided below, including with reference to the drawings and specific examples and implementations.

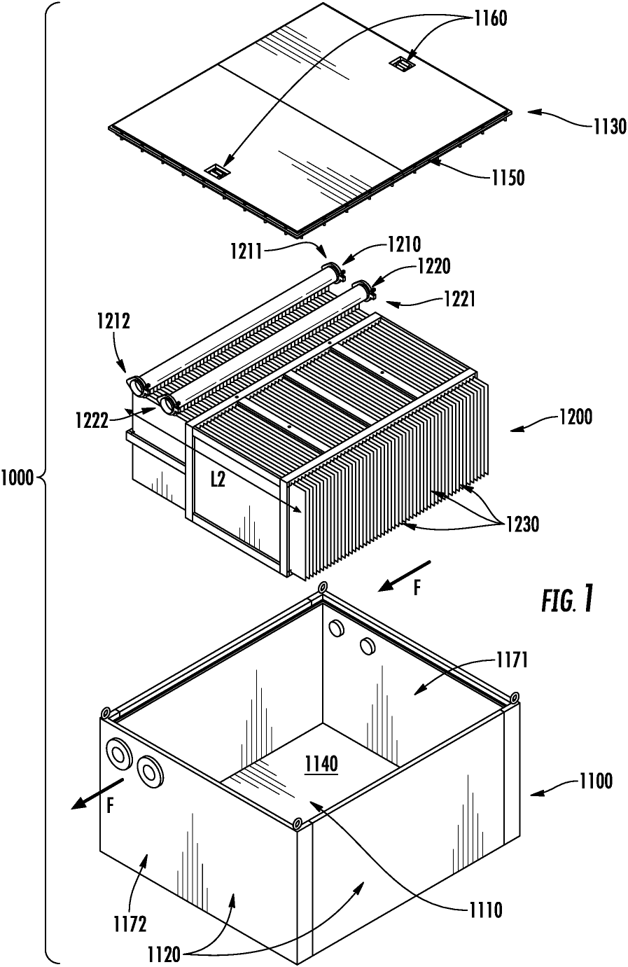

Briefly, with reference to the drawings, FIG. 1 illustrates an exploded perspective view of one non-limiting, exemplary embodiment of a thermal energy storage system described herein. As illustrated in FIG. 1, a thermal energy storage system (1000) comprises a container (1100), a heat exchanger (1200) disposed within the container (1100), and a PCM (not shown) disposed within the container (1100). The container (1100) is defined by a floor (1110), side walls (1120), and a cover (1130). It should be noted that FIG. 1 illustrates an exploded view, in which the heat exchanger (1200) is illustrated above the container (1100) for clarity, and in which the cover (1130) is illustrated above the heat exchanger (1200) for clarity. As understood by one of ordinary skill in the art, the heat exchanger (1200) is disposed within the container (1100) (more specifically, within the interior volume (1140) of the container (1100)) in an assembled system (1000), and the cover (1130) serves to enclose the interior (1140) of the assembled system (1000).

It should further be noted that the PCM (or PCM composition) is not explicitly shown for clarity. However, in the embodiment of FIG. 1, the PCM (or PCM composition) would occupy a portion of the interior volume (1140) of the container (1100) that is not occupied by the heat exchanger (1200). More specifically, the heat exchanger (1200) can be considered to be “immersed” or “embedded” in a “pool” or “block” of the PCM (or PCM composition). The “pool” or “block” of PCM, in some cases, could “rise” or extend from the floor (1110) of the container (1100) to a level within the interior volume (1140) corresponding to line “L1” illustrated on the container (1100), or corresponding to line “L2” illustrated on the heat exchanger (1200), or corresponding to some other “fill level,” where the “fill level” may be selected based on a desired degree of “immersion” of the plates (1230) of the heat exchanger (1200), based on a desired thermal mass or latent heat capacity of the PCM, and/or based on ease of installation or maintenance of the system (1000). It is to be understood that the PCM (or PCM composition) is in thermal contact with the plates (1230), such as may be especially provided by direct physical contact between the PCM and exterior surfaces of the plates (1230). As illustrated in FIG. 1, the number n of plates (1230) is about 52. However, as described herein, other numbers of plates may also be used.

As illustrated in FIG. 1, the heat exchanger (1200) comprises an inlet pipe or header (1210), an outlet pipe or header (1220), and a number n of plates (1230) in fluid communication with the inlet pipe (1210) and the outlet pipe (1220). Exemplary details regarding fixtures, openings, or apertures connecting the inlet pipe (1210) and the outlet pipe (1220) to the plates (1230) are described further hereinbelow. A flowing fluid (represented by arrows F in FIG. 1) that flows from the inlet pipe (1210) to the outlet pipe (1220) flows through the plates (1230) in between the inlet pipe (1210) and the outlet pipe (1220). As illustrated schematically by the arrows F in FIG. 1 and as further described herein, the fluid (F) can generally enter the heat exchange apparatus (1200) through a “proximal” end (1211) of the inlet pipe (1210) and generally exit the heat exchange apparatus (1200) through a “distal” end (1222) of the outlet pipe (1220) or (in some cases) through a distal end (1212) of the inlet pipe (1210). It should further be noted that the assignment of a specific pipe or header as the “inlet” or “outlet” pipe is not necessarily fixed, but instead can be based on the direction of flow of a fluid in a specific instance. Thus, it should be generally understood that the inlet pipe (1210) and the outlet pipe (1220) could be reversed in terms of their position in the structure of the heat exchanger (1200) without changing the principles of operation of the system (1000). Likewise, the direction of flow of the fluid (F) could be reversed without changing the principles of operation of the system (1000).

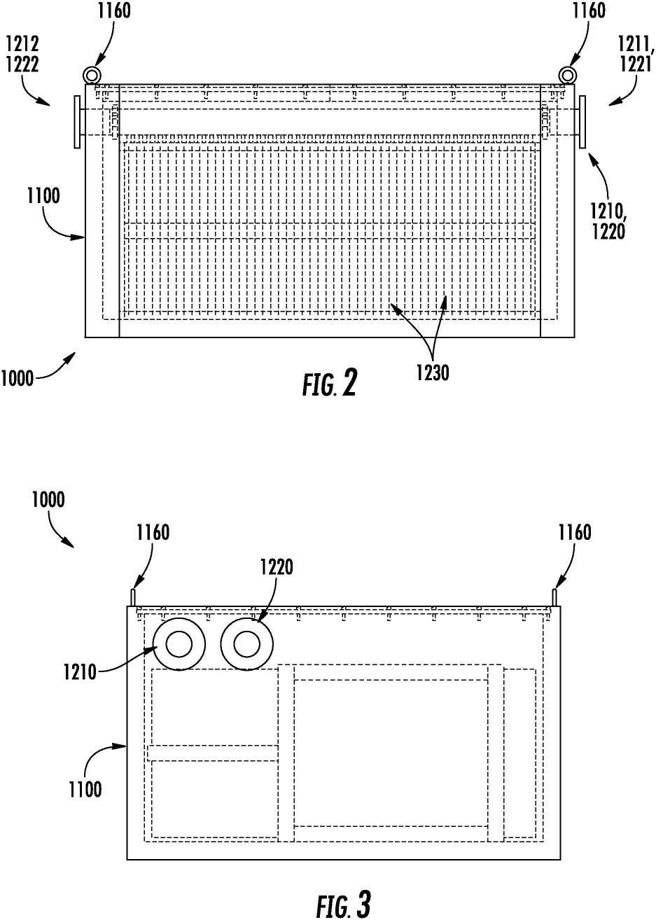

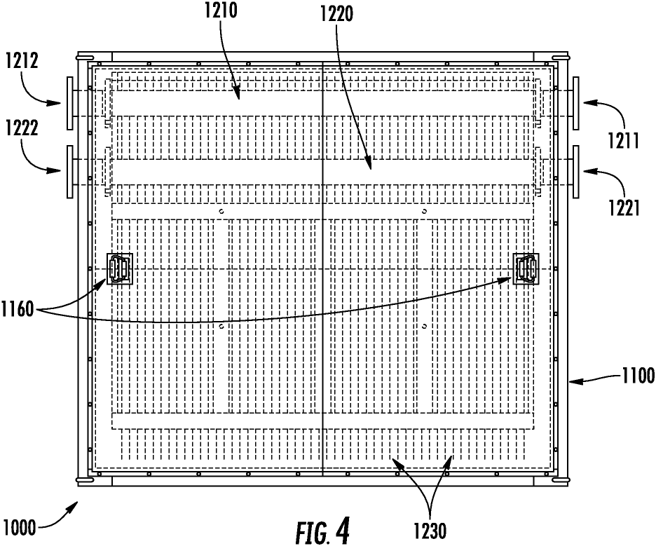

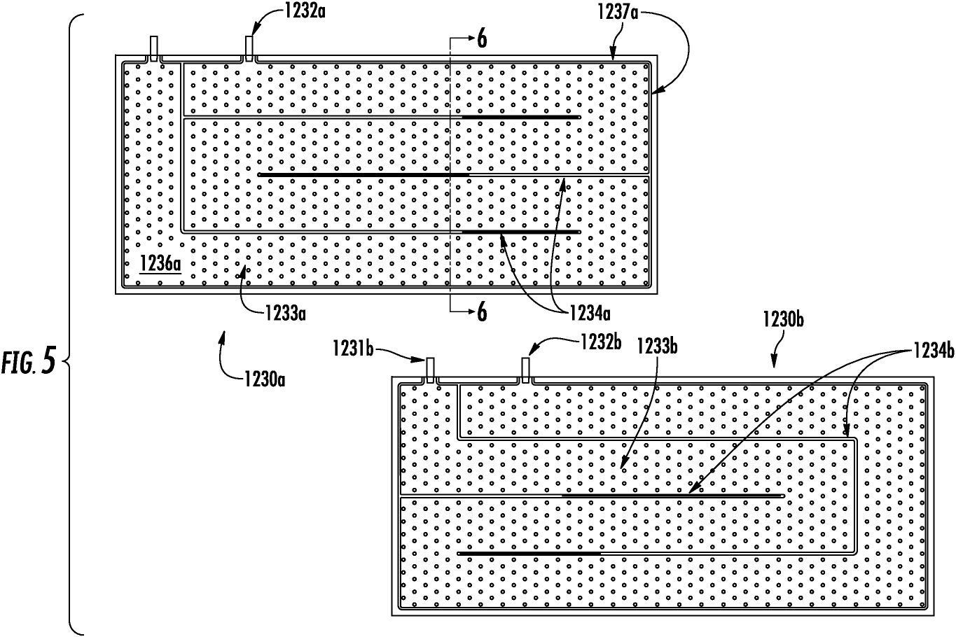

Additional views of the thermal energy storage system (1000) of FIG. 1 are provided in FIGS. 2-4, in which similar reference numbers denote similar features as in FIG. 1, and in which the thermal energy storage system (1000) is depicted in non-exploded (i.e., “assembled”) views. FIG. 2 illustrates a sectional side view of the thermal energy storage system of FIG. 1. FIG. 3 illustrates a view of a side adjacent to the side illustrated sectionally in FIG. 2. FIG. 4 illustrates a top plan view of the thermal energy storage system of FIG. 1.

Specific components of thermal energy storage systems described herein will now be described in more detail. Systems described herein comprise a container. Any container not inconsistent with the objectives of the present disclosure may be used. Moreover, the container can have any size, shape, and dimensions and be formed from any material or combination of materials not inconsistent with the objectives of the present disclosure. In some embodiments, for example, the container is made from one or more weather-resistant materials, thereby permitting installation of the system in an outdoor environment. In some cases, the container is metal or formed from a metal or a mixture or alloy of metals, such as iron or steel. In other instances, the container is formed from plastic or a composite material, such as a composite fiber or fiberglass material. In some cases, the container is formed from a polyolefin such as polypropylene or polyethylene, including a high density polyolefin such as high density polyethylene (HDPE).

Additionally, in some instances, the container of a system described herein provides functionality beyond containment of the PCM and heat exchanger. For example, in some cases, a container comprises exterior walls, interior walls, and a thermally insulating material disposed in between the exterior walls and the interior walls. Any thermally insulating material not inconsistent with the objectives of the present disclosure may be used. In some embodiments, the thermally insulating material is air or a vacuum. In other cases, the thermally insulating material comprises a foam, such as a polyisocyanurate foam. Further, in some instances, the exterior walls and/or the interior walls of the container are formed from a metal, plastic, composite material, or a combination of two or more of the foregoing. It is further to be understood that such exterior and interior walls (as well as anything disposed between them, such as a thermally insulating material) can together form each “side wall” and “floor” of the container, as the “side walls” and “floor” are denoted in FIG. 1. Similarly, in some instances, a cover of a container described herein likewise comprises exterior walls, interior walls, and a thermally insulating material disposed in between the exterior walls and interior walls. Further, in some implementations, the “cover” as denoted in FIG. 1 is formed from such a “multilayered” or composite cover, though the individual layers (e.g., the thermally insulating material disposed within the cover) are not expressly shown in FIG. 1.

Moreover, in some embodiments described herein, the floor, side walls, and/or cover of the container have an R-value of at least 4 square-foot*degree Fahrenheit*hour per British thermal unit per inch (ft²*°F*h/BTU*inch). In some cases, the floor, side walls, and/or cover of the container have an R-value of at least 5, at least 6, or at least 8 (ft²*°F*h/BTU*inch). In some instances, the R-value of the floor, side walls, and/or cover is between 4 and 10, between 4 and 8, between 4 and 6, between 5 and 10, between 5 and 8, or between 6 and 10 (ft²*°F*h/BTU*inch).

Additionally, in some cases, a gasket, seal, or sealing layer is disposed between the cover and the side walls of a container described herein or is disposed within or forms part of the cover. Such a gasket may be part of the main body of the container, or part of the cover of the container. Further, such a gasket can provide further thermal insulation and/or protection of the interior volume of the container from external factors such as water or other materials that may be present in the exterior environment of the container/system, particularly when the container/system is disposed or installed outdoors. The container of a system described herein may also include or comprise lugs or other features on one or more exterior surfaces of the container, such as one or more detachable lifting lugs disposed on one or more exterior surfaces of the container. FIG. 1 illustrates non-limiting examples of a gasket (1150) and lifting lugs (1160) of a container (1100).

Moreover, in some preferred embodiments, it is particularly to be noted that the container is not a standard shipping container. For example, in some embodiments, the container is not a container specifically approved by the Department of Transportation for shipping, such as a container having exterior dimensions of 20 feet by 8 feet by 8 feet. A container for use in a thermal energy storage system described herein, in some embodiments, can have other dimensions. The size and shape of the container, in some embodiments, are selected based on one or more of a desired thermal energy storage capacity of the system, a desired footprint of the system, and a desired stackability or portability of the system. For example, although the container is not itself a standard shipping container, it is to be understood that a container of a thermal energy management system described herein can be fitted or placed inside of a standard shipping container, such as for ease of shipment or transport of the system. In some preferred embodiments, the container of a thermal energy management system described herein has overall length, width, and height dimensions that permit two containers of two separate systems to be stacked on top of another (two high) and then placed within a standard shipping container. Further, in some cases, the overall dimensions of each container of each separate system are selected to permit an integral number (e.g., 4, 5, or 6) of “two-high” stacks to be placed or fitted within the interior of a standard shipping container. However, the exterior dimensions of the container of a thermal energy storage system described herein are not particularly limited, and other dimensions may also be used.

Turning now to the relationship between the container of a system described herein and the heat exchanger disposed within the container, it is to be understood that the heat exchanger or heat exchange apparatus can be disposed, installed, or fitted within the container (e.g., within or primarily within the interior volume of the container) in any manner not inconsistent with the objectives of the present disclosure. For example, in some cases, the entire volume or almost the entire volume of the heat exchanger is disposed within the interior space of the container, and only a small portion or only one or more connector portions of the heat exchanger are disposed or configured outside the container for purposes of providing access to the plates or other majority portion of the heat exchanger inside the container. In some embodiments, for instance, the inlet pipe of the heat exchanger (or a connector portion thereof) passes through (or partially through) an exterior wall of the container, thereby providing fluid communication between the plates and an exterior of the container. Similarly, in some cases, the outlet pipe (or a connector portion thereof) of the heat exchanger passes through (or partially through) an exterior wall of the container, thereby providing fluid communication between the plates and an exterior of the container.

As described further herein, it is to be understood that various exterior systems can be connected to the thermal energy management system, such that fluid communication is provided between the plates of the thermal energy management system and the exterior systems. For instance, in some cases, an HVAC chiller or source of waste heat (external to the thermal energy management system itself) is attached to or associated with the thermal energy management system.

In some preferred embodiments, with reference to FIG. 1, a first end (1211) of the inlet pipe (1210) of the heat exchanger (1200) passes through a first exterior wall (1171) of the container (1100), thereby providing fluid communication between the plates (1230) and an exterior of the container (1100). A second end (1212) of the inlet pipe (1210), opposite the first end (1211), passes through a second exterior wall (1172) of the container (1100). Moreover, in some cases, a first end (1221) of the outlet pipe (1220) of the heat exchanger (1200) passes through the first exterior wall (1171) of the container (1100). A second end (1222) of the outlet pipe (1220), opposite the first end (1221), passes through the second exterior wall (1172) of the container (1100), thereby providing fluid communication between the plates (1230) and an exterior of the container (1100). Additionally, in some embodiments, the second end (1212) of the inlet pipe (1210) is capped or sealed or closed, such that fluid communication between the plates (1230) and an exterior of the container (1100) is prevented through the second end (1212) of the inlet pipe (1210). Further, in some cases, the first end (1221) of the outlet pipe (1220) is capped or sealed or closed, such that fluid communication between the plates (1230) and an exterior of the container (1100) is prevented through the first end (1221) of the outlet pipe (1220). As illustrated in FIG. 1, the first exterior wall (1171) of the container (1100) and the second exterior wall (1172) of the container (1100) are in facing opposition to one another.

Turning once again to certain preferred embodiments, in some cases, the n plates of a thermal energy storage system described herein are in fluid communication with the inlet pipe and the outlet pipe in parallel with one another. It is to be understood that heat exchange or thermal transfer plates that are arranged “in parallel” are each independently connected to the inlet and outlet pipes, such that a specific portion or “plug” of fluid flowing from the inlet pipe, through a given plate, and then into the outlet pipe flows through only that given plate (as opposed to flowing through more than one plate). This “in parallel” configuration differs from a “serial” or “in series” arrangement in which a specific portion of fluid flowing from the inlet pipe to the outlet pipe flows through a plurality of plates in between the inlet pipe and the outlet pipe. In other words, prior to entering the outlet pipe for the first time, the fluid flows through at least a first plate and also a second plate in sequence. Such a flow path would occur, for instance, if the first plate were in direct fluid communication with the second plate but not with the outlet pipe, such that fluid flowing through the first plate would be forced to also flow through the second plate prior to reaching the outlet pipe. In a “parallel” arrangement, each plate includes its “own” direct connection or fitting or orifice providing fluid communication to the inlet pipe, and also its “own” direct connection or fitting or orifice providing fluid communication to the outlet pipe. Thus, in some preferred embodiments, the n plates are not in fluid communication with the inlet pipe and the outlet pipe in series with one another and are not in direct fluid communication with each other.

Moreover, in some instances, fluid flows through immediately adjacent plates in generally opposite or complementary directions. In some such cases, the fluid flows through immediately adjacent plates in opposite or complementary directions such that there is a counter flow condition in the adjacent plates. As described further herein, such a flow condition can be obtained when immediately adjacent plates have (generally) “mirrored” or opposite flow patterns or channels (e.g., where a first plate exhibits an “up-down-up-down” or “left-right-left-right” flow pattern, while the second, immediately adjacent plate exhibits a “down-up-down-up” or “right-left-right-left” flow pattern, where “up” and “down” and “left” and “right” are relative to gravity or to the floor of the container of the system). Further, for a set of n plates, in some cases, two “types” or patterns of plate can be used in an A-B-A-B alternating arrangement, thereby obtaining a flow pattern throughout all the plates that generally exhibits “counter flow” or alternating directional flow as a function of space or distance perpendicular to the major plane of the array or “stack” of plates. Counter flow could be achieved in other ways as well, as described further herein.

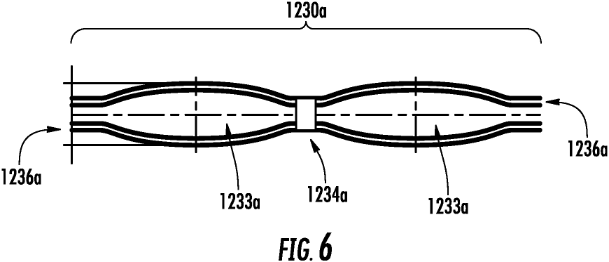

One non-limiting example of a “pair” of adjacent plates in which such counter flow can be achieved is illustrated in FIG. 5, which is a side view of two adjacent plates. With reference to FIG. 5, a first plate (1230a) comprises a first inlet orifice, fitting, or connection (1231a) and a first outlet, orifice, fitting, or connection (1232a). Fluid (not shown) flowing from the first inlet fitting (1231a) to the first outlet fitting (1232a) flows through a first flow path or channel (1233a). The first flow path or channel (1233a) is defined by first joined regions or barriers (1234a). The structure of such joined regions or barriers is described further hereinbelow. As illustrated in FIG. 5, the first flow path or channel (1233a) is a baffled flow path. Again with reference to FIG. 5, a second plate (1230b) is immediately adjacent to the first plate (1230a) when disposed in the heat exchanger (1200), though the plates (1230a, 1230b) are not depicted in this manner in FIG. 5, for purposes of clarity. The second plate (1230b) comprises a second inlet orifice, fitting, or connection (1231b) and a second outlet orifice, fitting, or connection (1232b). Fluid (not shown) flowing from the second inlet fitting (1231b) to the second outlet fitting (1232b) flows through a second flow path or channel (1233b). The second flow path or channel (1233b) is defined by second joined regions or barriers (1234b). Again, the structure of such joined regions or barriers is described further hereinbelow. Like the first flow path or channel (1233a), the second flow path or channel (1233b) is a baffled flow path. Additionally, it can readily be observed that the first and second flow paths (1233a, 1233b) are opposite, complementary, or counter flowing, in the sense that fluid flowing along the paths (1233a, 1233b) take opposite, complementary, or counter flow “turns” or changes of direction. Not intending to be bound by theory, it is believed that such opposite, complementary, or counter flow paths in adjacent plates provides improved performance by more evenly distributing thermal energy exchange “events” or activity on the exterior surface of the plates and thus within the body of PCM disposed in the container. It is further believed that the thermal mass or latent heat of the totality of the PCM disposed in the container is therefore used more efficiently, as opposed to only some portions, areas, or volumes of PCM undergoing a heat transfer event (or phase change), while other portions, areas, or volumes of PCM are largely thermal “spectators.”

Again turning to certain features of thermal energy storage systems described herein, in some preferred embodiments, the inlet pipe, the outlet pipe, and the n plates of a thermal energy storage system define n separate flow paths between the first (or proximal or inlet) end of the inlet pipe or heat exchanger and the second (or more distal or outlet) end of the outlet pipe or heat exchanger. Further, in some preferred embodiments, the n separate flow paths have the same or substantially the same length. For reference purposes herein, it is to be understood that a length, dimension, or other quantifiable unit or value described herein as “substantially” the same as another unit or value differs from the other unit or value by 10% or less, 5% or less, 3% or less, or 1% or less. Similarly, in some cases, the n plates have n flow velocities within the plates, and the n flow velocities have the same or substantially the same magnitude. Not intending to be bound by theory, it is believed that such uniformity or substantial uniformity of flow path and/or flow velocity within the heat exchanger can be provided by the structure of the inlet and outlet pipes and the structure of the heat transfer plates described herein, including with respect to how the inlet pipe, outlet pipe, and plates are connected to one another and with respect to the “opening” or “closing” of possible flow paths within the heat exchanger. Again not intending to be bound by theory, it is believed that uniform or substantially uniform flow paths and/or flow velocities can in turn provide improved thermal energy exchange between the PCM and the fluid flowing through the system.

Thermal energy storage systems described herein can also avoid undesired pressure drop exhibited by some other systems. In some embodiments, the n plates are connected to the inlet pipe by n inlet fittings, and the cross-sectional area of the inlet pipe is at least 0.8 times the total cross-sectional areas of the n inlet fittings combined, or is greater than or equal to the total cross-sectional areas of the n inlet fittings combined. In some instances, the cross-sectional area of the inlet pipe is greater than the total cross-sectional areas of the n inlet fittings combined. Moreover, in some cases, the n plates are connected to the outlet pipe by n outlet fittings, and the cross-sectional area of the outlet pipe is at least 0.8 times the total cross-sectional areas of the n outlet fittings combined, or is greater than or equal to the total cross-sectional areas of the n outlet fittings combined. In some embodiments, the cross-sectional area of the outlet pipe is greater than the total cross-sectional areas of the n outlet fittings combined.

Additionally, in some cases, the plates (or each plate, or one or more of the plates) of a thermal energy storage system described herein have or are defined by two heat transfer surfaces in facing opposition to one another, the two heat transfer surfaces being joined to one another to form four edges. Further, the edges can be relatively thin compared to the heat transfer surfaces. For instance, in some cases, the average length and the average width of the two heat transfer surfaces are at least 50 times, at least 100 times, at least 200 times, or at least 500 times the average thickness of the four edges. In some cases, the average length and the average width of the two heat transfer surfaces are 50-1000, 50-500, 100-1000, or 100-500 times the average thickness of the four edges.

Moreover, as described above, the two heat transfer surfaces can define one or more interior fluid flow channels, in between the two surfaces. Such flow channels or paths are illustrated, for instance, in FIG. 5. As described above, in some cases, the one or more channels include includes a plurality of baffles or switchbacks, or have a baffle structure. Moreover, in some embodiments, the one or more channels are defined by a plurality of joined or “sealed” regions of the two heat transfer surfaces, such as may be provided, for instance, by regions where the surfaces are welded together (e.g., by laser welding) or joined with one or more mechanical fasteners (e.g., rivets), provided that the joined or sealed regions do not permit flow or substantial flow of the fluid across or through the regions (that is, the regions act as barriers to fluid flow).

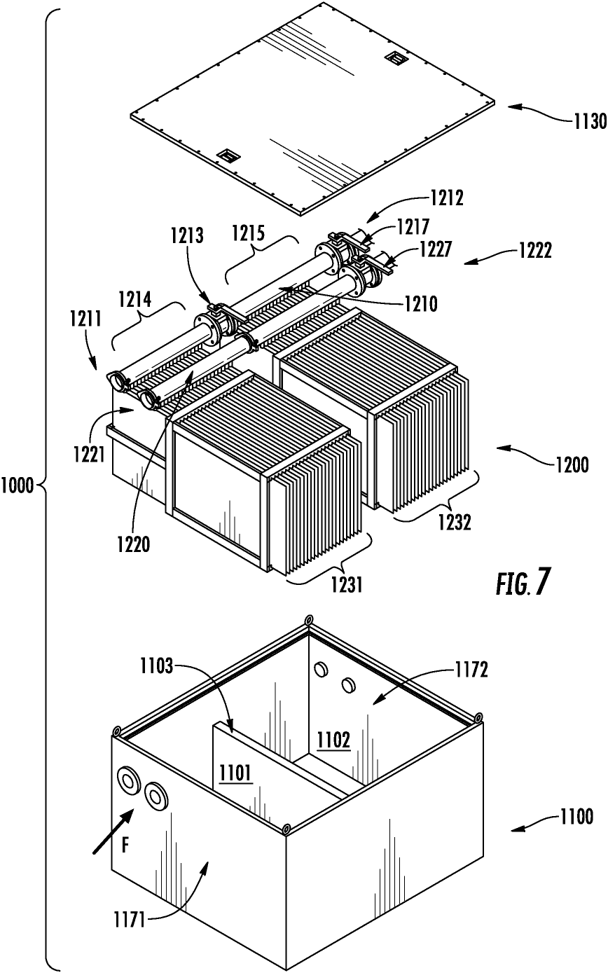

The foregoing features may be further understood with reference to FIG. 6, which illustrates a sectional view of a portion of a single plate (e.g., plate 1230a in FIG. 5), where the section is taken, for instance, along line 6--6 in FIG. 5. In FIG. 6, the plate (1230a) has two heat transfer surfaces (1236a in FIG. 5 and FIG. 6) in facing opposition to one another, the two heat transfer surfaces (1236a) being joined to one another to form edges (1237a in FIG. 5) at or around the perimeter of the plate. The two heat transfer surfaces (1236a) define one or more interior fluid flow channels (1233a; in FIG. 6, two channels or portions of a single channel are shown) in between the two surfaces (1236a). The one or more channels are defined by a plurality of joined and “sealed” regions (1234a; in FIG. 6, one joined or sealed region is shown; in FIG. 5, the joined or sealed regions are more readily observed to define “lines,” barriers, or flow paths).

In addition, in preferred embodiments of a thermal energy storage system described herein, the plates of the heat exchanger are substantially parallel to one another (here, “parallel” refers to spatial alignment, as opposed to the use of “in parallel” hereinabove, which referred to flow path). As described above, it is to be understood that two or more plates that are “substantially” parallel to one another are offset or off-axis by less than about 10 degrees, less than about 5 degrees, less than about 3 degrees, or less than about 1 degree. Such parallel plates are readily observed in FIGS. 1, 2, and 4, for instance. Moreover, in some cases, the plates are spaced apart from one another by an average distance (d) defined by one of Equations (1)-(3):

$$d = 0.28 k + \text{1} \text{.33,} \text{for} 0.01 < k < 0.40 \text{W} / \text{m} . \text{K,}$$

$$d = 0.23 k + 1.34 , \text{for} 0.41 < k < 1.00 \text{W} / \text{m} . \text{K}$$

$$d = 0.12 k + 1.44 , \text{for} k > 1.01 \text{W} / \text{m} . \text{K}$$

where d is the average plate-to-plate distance in inches and k is the thermal conductivity of the phase change material in contact with the plates. Applicant has discovered that such an average spacing of parallel plates described herein can improve system performance. Not intending to be bound by theory, it is believed that an average spacing described herein can improve the efficiency and homogeneity of thermal energy transfer and phase change events/activity through the total mass or body of PCM disposed in the system. It is further to be understood that the plates of a heat exchanger described herein can be formed from any material not inconsistent with the objectives of the present disclosure. In some cases, for instance, the plates are formed from metal.

Turning now to the phase change material of a thermal energy storage system described herein, the PCM composition as described in Section I, in some preferred embodiments, is in direct physical contact with heat exchange surfaces of the plates. For example, in some cases, as described above, the heat exchanger is at least partially embedded in the phase change material.

Any PCM (or PCM composition) as described in Section I may be used in a thermal energy storage system described herein. Moreover, the PCM (or combination of PCMs) used in a particular instance can be selected based on a relevant operational temperature range for the specific end use or application. For example, in some cases, the PCM has a phase transition temperature within a range suitable for heating or cooling a residential or commercial building. In other instance, the PCM has a phase transition temperature suitable for the thermal energy management of so-called waste heat. In some embodiments, the PCM has a phase transition temperature within one of the ranges of Table 1 below.

TABLE 1

Phase transition temperature ranges for PCMs.
Phase Transition Temperature Ranges
450-550° C.
300-550° C.
70-100° C.
60-80° C.
40-60° C.
40-50° C.
16-23° C.
16-18° C.
15-20° C.
4-10° C.
6-8° C.
-40 to -10° C.

As described further herein, a particular range can be selected based on the desired application. For example, PCMs having a phase transition temperature of 15-20° C. can be especially desirable to assist in the cooling of nuclear reactor fuel rod cooling pools, while PCMs having a phase transition temperature of 6-8° C. can be especially desirable for HVAC energy storage support. As another non-limiting example, PCMs having a phase transition between -40° C. and -10° C. can be preferred for use in space applications or for support of commercial freezer cooling.

Further, a PCM of a thermal energy storage system described herein can either absorb or release energy using any phase transition not inconsistent with the objectives of the present disclosure. For example, the phase transition of a PCM described herein, in some embodiments, comprises a transition between a solid phase and a liquid phase of the PCM, or between a solid phase and a mesophase of the PCM. A mesophase, in some cases, is a gel phase. Thus, in some instances, a PCM undergoes a solid-to-gel transition.

Moreover, in some cases, a PCM or mixture of PCMs has a phase transition enthalpy of at least about 50 kJ/kg or at least about 100 kJ/kg. In other embodiments, a PCM or mixture of PCMs has a phase transition enthalpy of at least about 150 kJ/kg, at least about 200 kJ/kg, at least about 300 kJ/kg, or at least about 350 kJ/kg. In some instances, a PCM or mixture of PCMs has a phase transition enthalpy between about 50 kJ/kg and about 350 kJ/kg, between about 100 kJ/kg and about 350 kJ/kg, between about 100 kJ/kg and about 220 kJ/kg, or between about 100 kJ/kg and about 250 kJ/kg.

In addition, a PCM (or PCM composition) of a thermal energy storage system described herein can have any composition not inconsistent with the objectives of the present disclosure and as described in Section I.

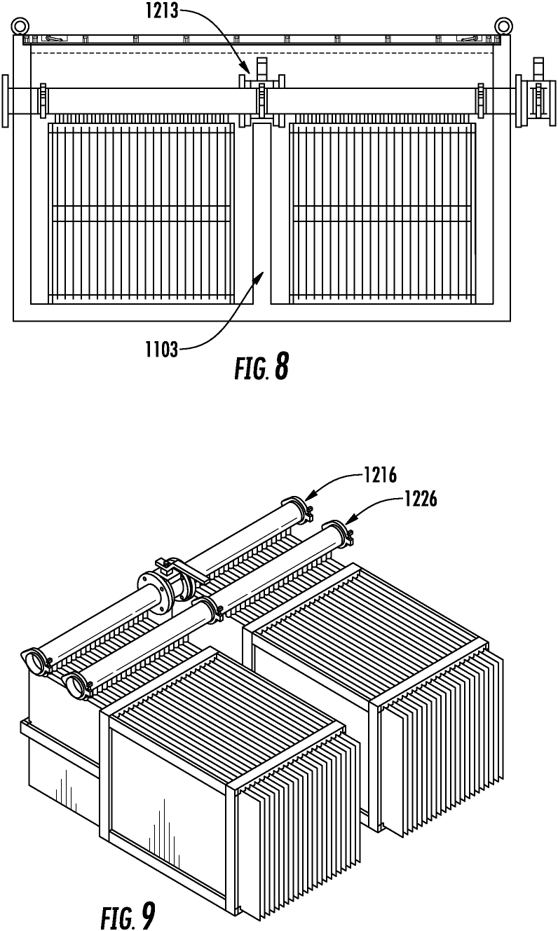

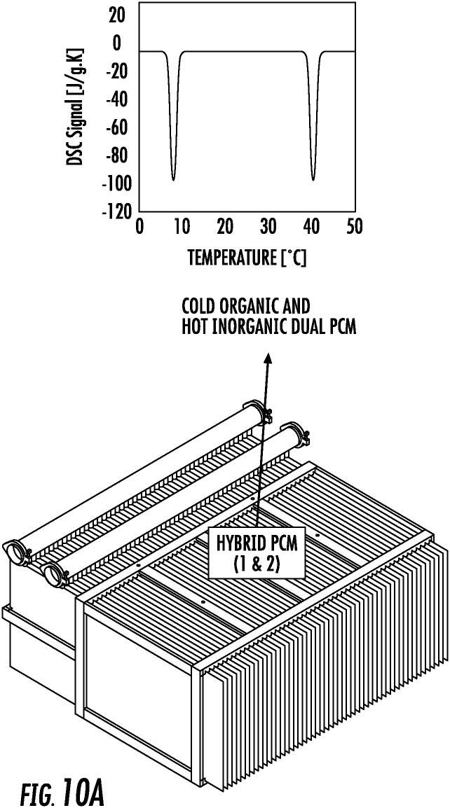

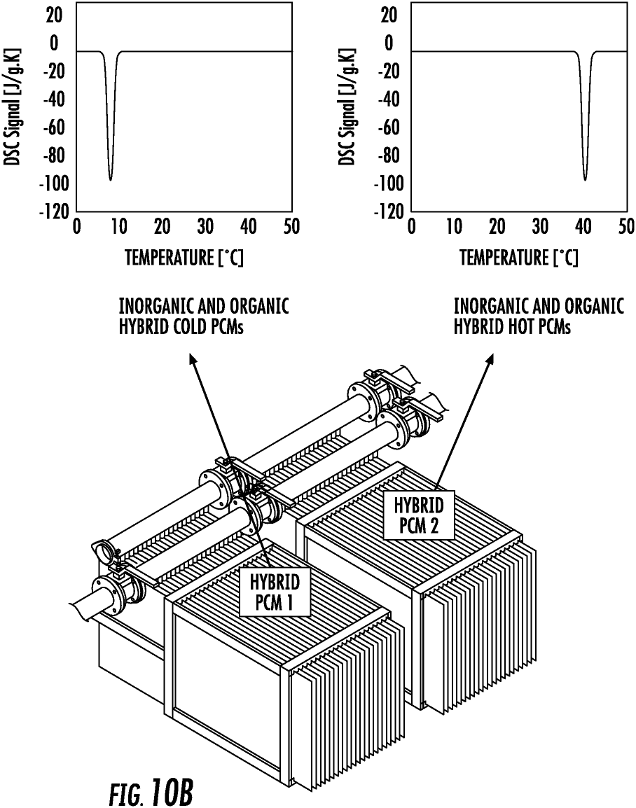

Exemplary implementations of thermal energy storage systems have been described above. In another embodiment, a thermal energy storage system described herein comprises a container that is subdivided into multiple compartments. One non-limiting example of such a system is illustrated in FIG. 7 and FIG. 8, with a further embodiment illustrated in FIG. 9. It should be noted that the reference numbers used in FIGS. 7-9 correspond, where relevant, to those used in FIGS. 1-4. It should further be noted that, for the sake of clarity of illustration, not all features are labeled in FIGS. 7-9.

With reference to FIGS. 7-9, the container (1100) of thermal energy storage system (1000) comprises a first chamber (1101) and a second chamber (1102) separated by a divider wall (1103) extending from the bottom toward the top of the container (1100). As illustrated in FIG. 7 and FIG. 8, the divider wall (1103) does not extend the entire distance between the top and bottom of the container (1100). The height of the divider wall (1103) instead matches or corresponds to the height or top of the heat exchanger (1200) disposed in the container (1100), or to a slightly larger height. A divider wall (1103) having such a height or extension in the vertical direction can effectively divide and sequester PCMs or PCM portions disposed in the two chambers (1101, 1102) while also not interfering with the configuration of the inlet pipe (1210) and the outlet pipe (1220). However, it is to be understood that a divider wall of a system described herein can have other structures also. It is further to be understood that, in some cases, the divider wall is thermally insulating or is formed from or contains a thermally insulating material, such as a foam.

Turning again to FIGS. 7-9, a first portion (1231) of the n plates (1230) is disposed in the first chamber (1101), and a second portion (1232) of the n plates (1230) is disposed in the second chamber (1102). The inlet pipe (1210) comprises a first valve (1213) having an open position and a closed position (the closed position is depicted in FIG. 7, in which a switch valve is depicted, such as a 4-inch switch valve). The valve (1213) divides the inlet pipe (1210) into a first portion (1214) and a second portion (1215). Further, the first valve (1213) is substantially aligned with the divider wall (1103), in terms of its placement along the direction defined by the long axis of the inlet pipe (1210). A first end (1211) of the inlet pipe (1210) passes through a first exterior wall (1171) of the container (1100), and a second end (1212) of the inlet pipe (1210), opposite the first end (1211), passes through a second exterior wall (1172) of the container (1100). Additionally, a first end (1221) of the outlet pipe (1220) passes through the first exterior wall (1171) of the container (1100). A second end (1222) of the outlet pipe (1220), opposite the first end (1221), passes through the second exterior wall (1172) of the container (1100). Moreover, the second end (1212) of the inlet pipe (1210) has an open configuration and a closed configuration. The second end (1222) of the outlet pipe (1220) also has an open configuration and a closed configuration.

The open and closed configurations of an end of an inlet pipe or outlet pipe can be provided by various structures or configurations. For example, in some non-limiting cases, a closed configuration is provided by placement of a blind flange or similar structure over an end of a pipe, and an open configuration is provided by removal or the absence of the blind flange (or structure), such that the end of the pipe is not blocked or sealed. In other instances, a closed configuration is provided by a valve, such as a switch valve or valved flange, in a closed position of the valve, and the open position is provided by the open position of the valve.

With reference to FIG. 9, in some cases the closed configuration of the second end (1212) of the inlet pipe (1210) is provided by a blind flange (1216) disposed over the second end (1212) of the inlet pipe (1210); and/or the closed configuration of the second end (1222) of the outlet pipe (1220) is provided by a blind flange (1226) disposed over the second end (1222) of the outlet pipe (1220). Alternatively, with reference to FIG. 7, the open configuration and the closed configuration of the second end (1212) of the inlet pipe (1210) are provided by a second valve (1217) disposed at the second end (1212) of the inlet pipe (1210), the second valve (1217) having an open position and a closed position; and/or the open configuration and the closed configuration of the second end (1222) of the outlet pipe (1220) are provided by a third valve (1227) disposed at the second end (1222) of the outlet pipe (1220), the third valve (1227) having an open position and a closed position. Any suitable valve not inconsistent with the objectives of the present disclosure may be used. In some embodiments, for example, the second valve is a flanged valve, and/or the third valve is a flanged valve.

Systems such as described above can be multifunctional and can operate in different modes. For example, in some cases, the first end of the outlet pipe is closed or sealed (e.g., by a blind flange, a closed valve, or otherwise). Moreover, when the first valve is in the open position, the second end of the inlet pipe is in the closed configuration (e.g., because the blind flange is present or the second valve is in the closed position), and the second end of the outlet pipe is in the open configuration (e.g., because a blind flange is not disposed over the second end of the outlet pipe, or the third valve is in the open position), fluid flows simultaneously from both the first portion of the inlet pipe and also from the second portion of the inlet pipe, through both the first portion of the n plates and also through the second portion of the n plates, and then from the first portion of the n plates and also the second portion of the n plates into the outlet pipe. Such a fluid flow is similar to the fluid flow of the embodiment of FIG. 1.

Alternatively, if the first valve is in the closed position, the second end of the inlet pipe is in the open configuration (e.g., because a blind flange is not disposed over the second end of the inlet pipe, or the second valve is in the open position), and the second end of the outlet pipe is in the closed configuration (e.g., because the blind flange is disposed over the second end of the outlet pipe, or the third valve is in the closed position), then fluid flows from the first portion of the inlet pipe into the first portion of the n plates, then from the first portion of the n plates into the outlet pipe, then from the outlet pipe into the second portion of the n plates, and then from the second portion of the n plates into the second portion of the inlet pipe. Such a configuration permits the first and second chambers of the container (along with, respectively, the first and second portions of the n plates) to perform independently as individual thermal energy storage systems or sub-systems. “Independent” or “modular” operation of this type can be particularly useful if different PCMs are disposed in the first and second chambers of the container.

In some embodiments described herein, a first PCM (or PCM composition) is disposed in the first chamber, and a second PCM (or PCM composition) is disposed in the second chamber. The first PCM composition and the second PCM composition can be the same or differing PCMs (or combinations of PCMs) having the same or differing phase transition temperatures. For example, in some cases, the first PCM and the second PCM are differing phase change materials having differing phase transition temperatures. In some such implementations, the first PCM has a higher phase transition temperature than the second PCM. Alternatively, in other embodiments, the first PCM has a lower phase transition temperature than the second PCM, as described further herein. Each of the first and second PCMs can have any phase transition temperature, latent heat, composition, and/or other property described herein for PCMs. Moreover, the properties of the PCMs can be selected to provide a desired modularity or multifunctionality to the thermal energy storage system. In some cases, for instance, the first PCM has a phase transition temperature of 15-25° C., and the second PCM has a phase transition temperature of 4-8° C. Thus, in some embodiments, a thermal energy storage system described herein can be a “dual” system (or “dual-mode system”), which can be used for both heating and cooling applications, as described further below. Additionally, in some such instances, while one PCM is being used as a source (or drain) of latent heat, the other PCM can provide a source (or drain) of sensible heat.

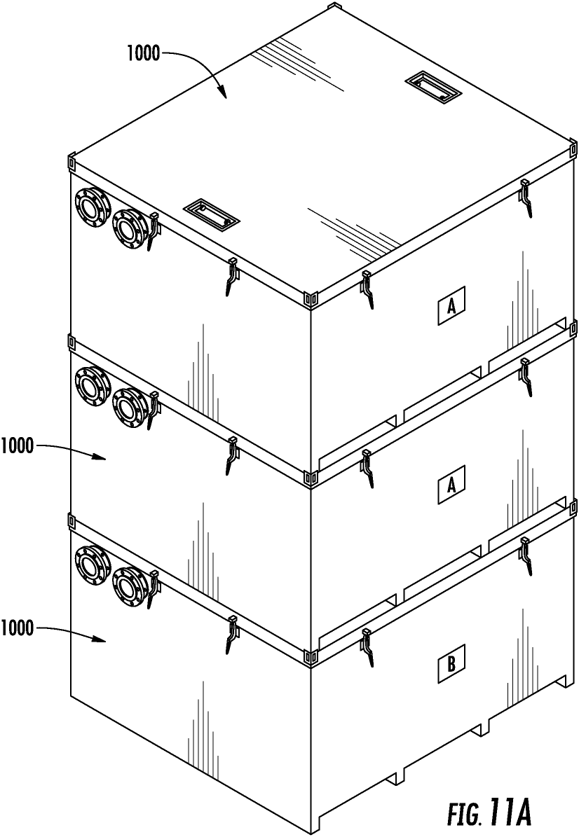

In some of the shown embodiments, different PCMs are disposed in the first and second chambers of a thermal energy storage system, the system being combined with a manifold equipped with an interior valve dividing the inlet pipe into two portions (with two different streams/inlets and outlet). In FIG. 10A, the thermal energy storage system is subdivided into two regions to provide two independent “modes” in a split-parallel configuration. By closing both interior valves, the thermal energy storage system can operate as two independent sub-systems, which can carry out two distinct heat transfer processes simultaneously. In the exemplary embodiment shown in FIG. 10A, one of the independent sub-systems stores “hot” (or relatively high temperature) latent energy, while the other sub-system simultaneously stores “cold” (or relatively low temperature) latent energy. By opening one interior valve, the thermal energy storage system can provide two “stages” of heat transfer in series.

In the embodiment shown in FIG. 10B, the container is a single chamber similar to the thermal energy storage system of FIG. 1. The container includes a PCM composition having differing phase transition temperatures. When the interior valve is open, the thermal energy storage system can provide a single stage with two distinct transition temperatures.

It is further to be understood that “dual-chamber” or “split-chamber” embodiments are not necessarily limited to only two separate chambers containing two differing PCMs, supported by one interior valve in the inlet pipe dividing the inlet pipe into two portions. Instead, as readily understood by one of ordinary skill in the art based on the present disclosure, the container of a thermal energy storage system described herein can be subdivided into any desired number of chambers to provide for any desired number of “stages” or “modes” of carrying out thermal energy storage and transfer (as opposed to providing only two “stages” or “modes.” Further, divider walls between such chambers can be aligned with respective additional valves in the inlet pipe, and the same or different PCMs can be disposed in the various chambers. In this manner, a thermal energy storage system described herein can be highly modular and highly versatile.

Moreover, it is also possible to obtain “staged” heating or cooling effects or multifunctional heat transfer by using a series of separate thermal energy storage systems described herein, instead of or in addition to using a single system having multiple chambers comprising multiple (differing) PCMs. For example, in some implementations, a thermal energy management system is described herein, the system comprising a first thermal energy storage system and a second thermal energy storage system, where both the first and second thermal energy storage systems comprise a thermal energy storage system described hereinabove. In some cases, the first energy storage system comprises a first container, a first heat exchanger disposed within the first container, and a first PCM disposed within the first container. The first heat exchanger comprises a first inlet pipe, a first outlet pipe, and a number n of first plates in fluid communication with the first inlet pipe and the first outlet pipe such that a fluid flowing from (or into) the first inlet pipe and to (or out of) the first outlet pipe flows through the first plates (or at least a portion or some of the first plates) in between the first inlet pipe and the first outlet pipe (or after flowing into the first inlet pipe but before flowing out of the first outlet pipe). Additionally, the first PCM is in thermal contact with the first plates. Similarly, the second thermal energy storage system can comprise a second container, a second heat exchanger disposed within the second container; and a second PCM disposed within the second container. The second heat exchanger comprises a second inlet pipe, a second outlet pipe, and a number m of second plates in fluid communication with the second inlet pipe and the second outlet pipe such that a fluid flowing from (or into) the second inlet pipe and to (or out of) the second outlet pipe flows through the second plates (or at least a portion or some of the second plates) in between the second inlet pipe and the second outlet pipe (or after flowing into the second inlet pipe but before flowing out of the second outlet pipe). The second PCM is in thermal contact with the second plates. Additionally, the number n and the number m are each at least 2. Further, the first outlet pipe of the first energy storage system is connected to the second inlet pipe of the second energy storage system.

It is to be understood that such a series of thermal energy storage systems is not limited to only two systems connected in series. Any desired number of individual thermal energy storage systems described herein could be used or connected with one another. Moreover, in some preferred embodiments in which multiple individual thermal energy storage systems described herein are connected with one another, the outlet of the nth system is connected to the inlet of the (n+1)th system using a straight pipe or connector, as opposed to a pipe or connector including an angle, bend, or elbow. Avoiding such turns or bends can help avoid undesired pressure differentials or pressure drops between individual systems.

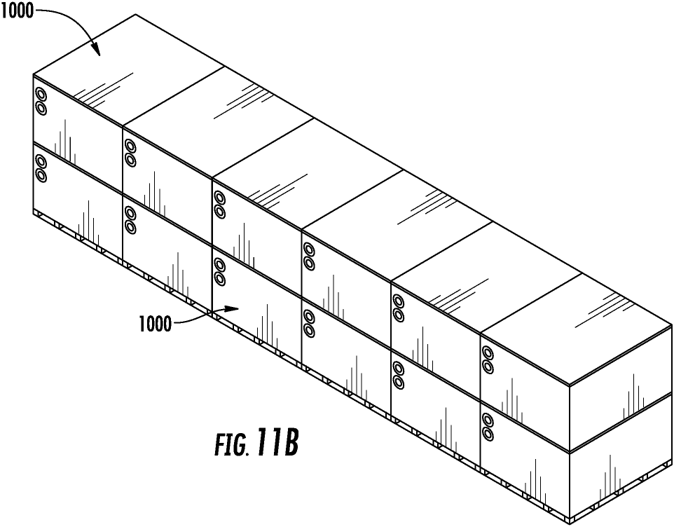

FIGS. 11A and 11B represent two non-limiting examples of a thermal energy management system described herein comprising multiple thermal energy storage systems connectable in series. For instance, FIG. 11A is an embodiment of n=3 individual thermal energy storage systems vertically stacked on each other, and FIG. 11B depicts an embodiment where n=12 individual thermal energy storage systems (as a 6x2 stack or array). Such embodiments are merely exemplary and should not be interpreted as limiting. The skilled artisan would appreciate that thermal energy management systems described herein can comprise n= 2, 3, 4, 5, 6, 7, 8, 9, 10, 11, 12, 13, 14, 15, 16, 17, 18, 19, 20, or more than 20 individual thermal energy storage systems. It is further to be noted that, in some embodiments, the cover of an individual thermal energy storage system described herein can include one or more protrusions for receiving the bottom of a second thermal energy storage system stacked on top of the first thermal energy storage system. For example, as illustrated in FIG. 11A, the cover (1130) of the topmost system (1000) comprises four L-shaped brackets or protrusions (1131) that are attached to or integrally formed with the cover (1130) and that extend upwardly from the cover (1130) to provide a “lip” or other ridge or barrier for receiving the bottom of an additional system (not shown) which (in the example embodiment of FIG. 11A) might be placed on top of the stack of three individual systems to form a stack of four systems. The thermal energy storage systems below also include such brackets (1131) at the four corners of the systems’ respective covers. The depth of the “lip” or other ridge can be any distance desired to help secure or “nest” or “receive” the bottom of the system placed on top (e.g., the depth from the top of the protrusion to the top of the cover may be 0.5-5 inches, 0.5-3 inches, 1-5 inches, or 1-3 inches). Moreover, fasteners other than the L-shaped brackets may also be used. For instance, one or more rods or sheet-shaped structures may be used if desired.

### IV. Methods of Storing and Releasing Thermal Energy

In another aspect, methods of storing and releasing or otherwise managing thermal energy are described herein. In some implementations, such a method comprises attaching a thermal energy storage system described herein (or a thermal energy management system described herein) to an external source of an external fluid. The thermal energy storage system (or thermal energy management system) can be any thermal energy storage system (or thermal energy management system) described hereinabove in Section I.

Moreover, as described further herein, the external fluid can be any external fluid not inconsistent with the objectives of the present disclosure. In some implementations, for instance, the fluid comprises a thermal fluid. For reference purposes herein, a thermal fluid can be a fluid having a high heat capacity. In some cases, a thermal fluid also exhibits high thermal conductivity. Moreover, the external fluid can be a liquid or a gas. A liquid fluid, in some embodiments, comprises a glycol, such as ethylene glycol, propylene glycol, and/or polyalkylene glycol. In some instances, a liquid fluid comprises liquid water or consists essentially of liquid water. A gaseous fluid, in some embodiments, comprises steam.

In addition, as described further herein, the external source of the external fluid can be any external source not inconsistent with the objectives of the present disclosure. In some preferred implementations, the external source of the external fluid is a source of heating or cooling, or a source of waste heat. In some cases, for instance, the external source of the external fluid comprises an HVAC chiller.

Methods described herein, in some embodiments, further comprise forcing a first portion of the external fluid through the heat exchanger of the thermal energy system. That is, the external fluid enters the heat exchanger through a proximal end and exits the heat exchanger through a distal end, having passed through the plates of the heat exchanger. Moreover, the first portion of the external fluid can enter the heat exchanger at a first or initial temperature (T1) and exit the heat exchanger at a second temperature (T2). Additionally, in some preferred embodiments, T1 and T2 are different. In some cases, T1 is higher than T2. Alternatively, in other instances, T1 is lower than T2.

It is further to be understood that, during the course of a method described herein, in some implementations, the first portion of the external fluid participates in thermal energy transfer or heat exchange with the PCM disposed in the container. For example, in some cases, the first portion of the external fluid transfers thermal energy or heat to the PCM, thereby lowering the temperature of the first portion of the external fluid. Additionally, in some such instances, the PCM stores at least a portion of the transferred thermal energy as latent heat (e.g., by undergoing a phase transition, such as a transition from a solid state to a liquid state).

Moreover, in some implementations, a method described herein further comprises forcing a second portion of the external fluid through the heat exchanger of the thermal energy system (e.g., at a later time), and transferring at least a portion of the stored latent heat from the PCM to the second portion of the external fluid, thereby increasing the temperature of the second portion of the external fluid.

In this manner, a thermal energy storage system described herein can store thermal energy during a first time interval and release it during a second time interval. For example, the system can store thermal energy when the PCM of the system is exposed to a relatively warm external fluid, where the relative warmth of the external fluid is based on the external fluid having a temperature that is greater than the relevant phase transition temperature of the PCM and greater than the temperature of the PCM. The system can release the stored thermal energy when the PCM of the system is later exposed to a relatively cool external fluid. Again, the relative coolness of the external fluid is based on the external fluid having a temperature that is lower than the temperature of the PCM at the time of thermal contact. Such a pattern of storing and releasing of thermal energy can be especially useful when it is desired to cool the external fluid during the first time interval. For instance, in some cases, the first fluid can be warm water associated with a chiller of an HVAC system or a fluid carrying “waste heat,” such as waste heat generated by or within a nuclear reactor cooling pool, or waste heat generated by steam released by an industrial process. It is to be understood that such cooling provided by a thermal energy storage system described herein can be considered to be “passive” cooling that does not require the input of energy from another source, such as a separate HVAC system or other cooling system. The thermal energy transferred to the PCM during such a passive cooling step can be considered to “discharge” or reduce the total thermal capacity of the mass of PCM disposed in the system. The thermal capacity of the PCM can be restored or “recharged” during the second time interval, when the heat transfer between the PCM and the external fluid proceeds in the opposite direction, as compared to when the initial cooling of the external fluid occurred. This “recharging” can be carried out, in some instances, when energy (e.g., obtained from the power grid and used to power a conventional HVAC system associated with the external fluid) is more abundant and/or less expensive, such as during “off peak” hours.

It is also possible for the storing-and-releasing cycle described above to be carried out in the opposite sequence—releasing of thermal energy (i.e., heating of the external fluid) followed by storing of thermal energy (i.e., cooling of the external fluid). Such a heat exchange cycle may be desirable when the thermal energy storage system is used to provide passive or “peak” heating, rather than cooling.

For example, in some implementations of a method described herein, the PCM transfers thermal energy or heat to the first portion of the external fluid, thereby increasing the temperature of the first portion of the external fluid. In such an instance, the PCM can transfer the thermal energy by discharging latent heat (e.g., by undergoing a phase transition, such as a transition from a liquid state to a solid state). Additionally, in some cases, the method further comprises forcing a second portion of the external fluid through the heat exchanger of the thermal energy system (e.g., at a later time period), and transferring thermal energy from the second portion of the external fluid to the PCM, thereby decreasing the temperature of the second portion of the external fluid.

### V. Embodiments

The following embodiments describe various alternative aspects of the compositions and systems using the compositions described herein. The following should not be construed as limiting, but, rather, a description of a variety of configurations and methods within the scope of the invention.

Embodiment 1: A composition comprising:
a first phase change material (PCM) component comprising an organic PCM;
a second PCM component comprising an inorganic PCM; and
a crosslinker linking the first PCM component to the second PCM component.

Embodiment 2: The composition of embodiment 1, wherein the first PCM component further comprises a first linking component.

Embodiment 3: The composition of any of the preceding embodiments, wherein the second PCM component further comprises a second linking component.

Embodiment 4: The composition of any of the preceding embodiments, wherein the first PCM component is a pre-gel or pre-crosslinked network mixture.

Embodiment 5: The composition of any of embodiments 1-3, wherein the first PCM component is a gel or a crosslinked network.

Embodiment 6: The composition of any of the preceding embodiments, wherein the second PCM component is a pre-gel or pre-crosslinked network mixture.

Embodiment 7: The composition of any of embodiments 1-5, wherein the second PCM component is a gel or a crosslinked network.

Embodiment 8: The composition of any of the preceding embodiments, wherein: the first PCM component is present in the composition in an amount of 30-70 weight percent (wt. %), based on the total weight of the composition; and the second PCM component is present in the composition in an amount of 30-70 wt.%, based on the total weight of the composition.

Embodiment 9: The composition of any of the preceding embodiments, wherein the organic PCM comprises one or more fatty acids, one or more fatty alcohols, one or more alkyl esters of a fatty acid, one or more fatty sulfonates or phosphonates, one or more paraffins, or a combination thereof.

Embodiment 10: The composition of any of the preceding embodiments, wherein the inorganic PCM comprises one or more of LiCH₃COO-2H₂O, KF·4H₂O, Mn(NO₃)₂·6H₂O, CaCl₂·6H₂O, CaBr₂·6H₂O, Li(NO₃)·6H₂O, Na₂SO₄ · 10H₂O, Na₂CO₃ · 10H₂O, Na₂HPO₄ · 12H₂O, Na₃PO₄ · 12H₂O, Ca(NO₃)₂ · 3H₂O, Na(NO₃)₂·6H₂O, Co(NO₃)₂·6H₂O, Ni(NO₃)₂·6H₂O, CH₃COONa·3H₂O, LiC₂H₃O₂·2H₂O, and MgCl₂·4H₂O.

Embodiment 11: The composition of any of the preceding embodiments, wherein: the organic PCM comprises methyl laurate, butyl myristate, propyl myristate, or a mixture of two or more of the foregoing; and the inorganic PCM comprises CaCl₂·6H₂O, Na₂SO₄· 10H₂O, Na₂CO₃ · 10H₂O, Na₂HPO₄ · 12H₂O, MgSO₄·7H₂O, NaCH₃COO·3H₂O, or a mixture of two or more of the foregoing.

Embodiment 12: The composition of any of the preceding embodiments, wherein the composition further comprises a polymeric material.

Embodiment 13: The composition of any of the preceding embodiments, wherein the composition further comprises an ionic liquid.

Embodiment 14: The composition of any of the preceding embodiments, wherein the composition further comprises an antimicrobial material.

Embodiment 15: The composition of any of the preceding embodiments, wherein the composition has a dynamic viscosity of greater than or equal to 300,000 cP at 20° C. and 1 atm.

Embodiment 16: The composition of any of the preceding embodiments, wherein the first PCM component and the second PCM component have a dynamic viscosity of greater than or equal to 300,000 cP at 20° C. and 1 atm.

Embodiment 17: A thermal energy storage system comprising:
a container;
a heat exchanger disposed within the container; and
the composition of any of embodiments 1-16 disposed within the container,
wherein the heat exchanger and the composition are in thermal contact with one another.

Embodiment 18: The system of embodiment 17, wherein the heat exchanger comprises:
an inlet pipe;
an outlet pipe; and
a number n of plates in fluid communication with the inlet pipe and the outlet pipe such that a fluid flowing from the inlet pipe and to the outlet pipe flows through the plates in between the inlet pipe and the outlet pipe; and
wherein the number n is at least 2.

Embodiment 19: The system of embodiment 17, wherein the container comprises exterior walls, interior walls, and a thermally insulating material disposed in between the exterior walls and the interior walls.

Embodiment 20: The system of embodiment 19, wherein the exterior walls and/or the interior walls are formed from a metal.

Embodiment 21: The system of embodiment 19, wherein the exterior walls and/or the interior walls are formed from plastic or a composite material.

Embodiment 22: The system of any of embodiments 19-21, wherein the thermally insulating material comprises a foam.

Embodiment 23: The system of any of embodiments 19-22, wherein the container is defined by a floor, side walls, and a cover.

Embodiment 24: The system of embodiment 23, wherein the floor, side walls, and/or cover of the container have an R-value of at least 4 square-foot*degree Fahrenheit*hour per British thermal unit per inch (ft²*°F*h/BTU*inch).

Embodiment 25: The system of embodiment 23 or embodiment 24, wherein a gasket is disposed between the cover and the side walls.

Embodiment 26: The system of any of embodiments 18-25, wherein the inlet pipe of the heat exchanger passes through an exterior wall of the container, thereby providing fluid communication between the plates and an exterior of the container.

Embodiment 27: The system of any of embodiments 18-26, wherein the outlet pipe of the heat exchanger passes through an exterior wall of the container, thereby providing fluid communication between the plates and an exterior of the container.

Embodiment 28: The system of any of embodiments 18-27, wherein: a first end of the inlet pipe of the heat exchanger passes through a first exterior wall of the container, thereby providing fluid communication between the plates and an exterior of the container; and a second end of the inlet pipe, opposite the first end, passes through a second exterior wall of the container.

Embodiment 29: The system of embodiment 28, wherein a first end of the outlet pipe of the heat exchanger passes through the first exterior wall of the container; and a second end of the outlet pipe of the heat exchanger passes through the second exterior wall of the container, thereby providing fluid communication between the plates and an exterior of the container.

Embodiment 30: The system of embodiment 29, wherein: the second end of the inlet pipe is capped, such that fluid communication between the plates and an exterior of the container is prevented through the second end of the inlet pipe; and the first end of the outlet pipe is capped, such that fluid communication between the plates and an exterior of the container is prevented through the first end of the outlet pipe.

Embodiment 31: The system of embodiment 30, wherein the first exterior wall of the container and the second exterior wall of the container are in facing opposition to one another.

Embodiment 32: The system of any of embodiments 17-31, wherein the heat exchanger is at least partially embedded in the composition.

Embodiment 33: The system of any of embodiments 17-32, wherein a phase change material of the composition has a phase transition temperature within one of the following ranges:
450-550° C.;
300-550° C.;
70-100° C.;
60-80° C.;
40-50° C.;
16-23° C.;
16-18° C.;
15-20° C.;
6-8° C.; and
-40 to -10° C.

Embodiment 34: The system of any of embodiments 18-33, wherein: the container comprises a first chamber and a second chamber separated by a divider wall;
a first portion of the n plates is disposed in the first chamber;
a second portion of the n plates is disposed in the second chamber;
the inlet pipe comprises a first valve having an open position and a closed position, the valve dividing the inlet pipe into a first portion and a second portion;
the first valve is substantially aligned with the divider wall;
a first end of the inlet pipe passes through a first exterior wall of the container;
a second end of the inlet pipe, opposite the first end, passes through a second exterior wall of the container;
a first end of the outlet pipe passes through the first exterior wall of the container;
a second end of the outlet pipe, opposite the first end, passes through the second exterior wall of the container;
the second end of the inlet pipe has an open configuration and a closed configuration; and
the second end of the outlet pipe has an open configuration and a closed configuration.

Embodiment 35: The system of embodiment 34, wherein: the closed configuration of the second end of the inlet pipe is provided by a blind flange disposed over the second end of the inlet pipe; and/or the closed configuration of the second end of the outlet pipe is provided by a blind flange disposed over the second end of the outlet pipe.

Embodiment 36: The system of embodiment 35, wherein: the open configuration and the closed configuration of the second end of the inlet pipe are provided by a second valve disposed at the second end of the inlet pipe, the second valve having an open position and a closed position; and/or the open configuration and the closed configuration of the second end of the outlet pipe are provided by a third valve disposed at the second end of the inlet pipe, the third valve having an open position and a closed position.

Embodiment 37: The system of embodiment 36, wherein: the second valve is a flanged valve; and/or the third valve is a flanged valve.

Embodiment 38: The system of any of embodiments 34-37, wherein: the first end of the outlet pipe is sealed; and when the first valve is in the open position, the second end of the inlet pipe is in the closed configuration, and the second end of the outlet pipe is in the open configuration, fluid flows simultaneously from both the first portion of the inlet pipe and also from the second portion of the inlet pipe, through both the first portion of the n plates and also through the second portion of the n plates, and then from the first portion of the n plates and also the second portion of the n plates into the outlet pipe.

Embodiment 39: The system of embodiment 38, wherein: the first end of the outlet pipe is sealed; and when the first valve is in the closed position, the second end of the inlet pipe is in the open configuration, and the second end of the outlet pipe is in the closed configuration, fluid flows from the first portion of the inlet pipe into the first portion of the n plates, then from the first portion of the n plates into the outlet pipe, then from the outlet pipe into the second portion of the n plates, and then from the second portion of the n plates into the second portion of the inlet pipe.

Embodiment 40: The system of any of embodiments 34-39, wherein: a first composition according to any one of embodiments 1-12 is disposed in the first chamber; and a second composition according to any one of embodiments 1-12 is disposed in the second chamber.

Embodiment 41: The system of embodiment 40, wherein the first composition and the second composition have the same composition and the same phase transition temperature, or have differing compositions and differing phase transition temperatures.

Embodiment 42: A method of storing and releasing thermal energy, the method comprising: attaching a thermal energy storage system to an external source of an external fluid, wherein the thermal energy storage system comprises the system of any of embodiments 17-41.

Embodiment 43: The method of embodiment 42, wherein the external fluid is liquid water.

Embodiment 44: The method of embodiment 43, wherein the external source of the external fluid comprises an HVAC chiller or source of waste heat.

Embodiment 45: The method of any of embodiments 42-44 further comprising: forcing a first portion of the external fluid through the heat exchanger of the thermal energy system.

Embodiment 46: The method of embodiment 45, wherein: the first portion of the external fluid enters the heat exchanger at a first temperature (T1) and exits the heat exchanger at a second temperature (T2); and T1 and T2 are different.

Embodiment 47: The method of embodiment 46, wherein T1 is higher than T2.

Embodiment 48: The method of embodiment 46, wherein T1 is lower than T2.

Embodiment 49: The method of any of embodiments 45-48, wherein: the first portion of the external fluid participates in thermal energy exchange with the PCM composition disposed in the container.

Embodiment 50: The method of embodiment 49, wherein the first portion of the external fluid transfers thermal energy to the PCM composition, thereby lowering the temperature of the first portion of the external fluid.

Embodiment 51: The method of embodiment 50, wherein the PCM composition stores at least a portion of the transferred thermal energy as latent heat.

Embodiment 52: The method of embodiment 51 further comprising: forcing a second portion of the external fluid through the heat exchanger of the thermal energy system; transferring at least a portion of the stored latent heat from the PCM composition to the second portion of the external fluid, thereby increasing the temperature of the second portion of the external fluid.

Embodiment 53: The method of embodiment 49, wherein the phase change material transfers thermal energy to the first portion of the external fluid, thereby increasing the temperature of the first portion of the external fluid.

Embodiment 54: The method of embodiment 53, wherein the PCM composition transfers the thermal energy by discharging latent heat.

Embodiment 55: The method of embodiment 54 further comprising: forcing a second portion of the external fluid through the heat exchanger of the thermal energy system; transferring thermal energy from the second portion of the external fluid to the phase change material, thereby decreasing the temperature of the second portion of the external fluid.

Embodiment 56: A method of making a composition of any of claims 1-16, comprising:
providing the first PCM component;
providing the second PCM component;
providing the crosslinker, and
combining the first PCM component and the second PCM component with the crosslinker.

Various implementations and embodiments of systems, apparatus, and methods have been described in fulfillment of the various objectives of the present disclosure. It should be recognized that these implementations and embodiments are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

That which is claimed is:

1. A composition comprising:
a first phase change material (PCM) component comprising an organic PCM;
a second PCM component comprising an inorganic PCM; and
a crosslinker linking the first PCM component to the second PCM component.

2. The composition of claim 1, wherein the first PCM component further comprises a first linking component.

3. The composition of any of the preceding claims, wherein the second PCM component further comprises a second linking component.

4. The composition of any of the preceding claims, wherein the first PCM component is a pre-gel or pre-crosslinked network mixture.

5. The composition of any of claims 1-3, wherein the first PCM component is a gel or a crosslinked network.

6. The composition of any of the preceding claims, wherein the second PCM component is a pre-gel or pre-crosslinked network mixture.

7. The composition of any of claims 1-5, wherein the second PCM component is a gel or a crosslinked network.

8. The composition of any of the preceding claims, wherein:
the first PCM component is present in the composition in an amount of 30-70 weight percent (wt. %), based on the total weight of the composition; and
the second PCM component is present in the composition in an amount of 30-70 wt.%, based on the total weight of the composition.

9. The composition of any of the preceding claims, wherein the organic PCM comprises one or more fatty acids, one or more fatty alcohols, one or more alkyl esters of a fatty acid, one or more fatty sulfonates or phosphonates, one or more paraffins, or a combination thereof.

10. The composition of any of the preceding claims, wherein the inorganic PCM comprises one or more of LiCH₃COO·2H₂O, KF·4H₂O, Mn(NO₃)₂·6H₂O, CaCl₂·6H₂O, CaBr₂·6H₂O, Li(NO₃)·6H₂O, Na₂SO₄·10H₂O, Na₂CO₃·10H₂O, Na₂HPO₄·12H₂O, Na₃PO₄·12H₂O, Ca(NO₃)₂·3H₂O, Na(NO₃)₂·6H₂O, Co(NO₃)₂·6H₂O, Ni(NO₃)₂·6H₂O, CH₃COONa·3H₂O, LiC₂H₃O₂·2H₂O, and MgCl₂·4H₂O.

11. The composition of any of the preceding claims, wherein:
the organic PCM comprises methyl laurate, butyl myristate, propyl myristate, or a mixture of two or more of the foregoing; and
the inorganic PCM comprises CaCl₂·6H₂O, Na₂SO₄·10H₂O, Na₂CO₃·10H₂O, Na₂HPO₄·12H₂O, MgSO₄·7H₂O, NaCH₃COO·3H₂O, or a mixture of two or more of the foregoing.

12. The composition of any of the preceding claims, wherein the composition further comprises a polymeric material.

13. The composition of any of the preceding claims, wherein the composition further comprises an ionic liquid.

14. The composition of any of the preceding claims, wherein the composition further comprises an antimicrobial material.

15. The composition of any of the preceding claims, wherein the composition has a dynamic viscosity of greater than or equal to 300,000 cP at 20° C. and 1 atm.

16. The composition of any of the preceding claims, wherein the first PCM component and the second PCM component have a dynamic viscosity of greater than or equal to 300,000 cP at 20° C. and 1 atm.

17. A thermal energy storage system comprising:
a container;
a heat exchanger disposed within the container; and
the composition of any of claims 1-16 disposed within the container,
wherein the heat exchanger and the composition are in thermal contact with one another.

18. The system of claim 17, wherein the heat exchanger comprises:
an inlet pipe;
an outlet pipe; and
a number n of plates in fluid communication with the inlet pipe and the outlet pipe such that a fluid flowing from the inlet pipe and to the outlet pipe flows through the plates in between the inlet pipe and the outlet pipe; and
wherein the number n is at least 2.

19. The system of claim 17, wherein the container comprises exterior walls, interior walls, and a thermally insulating material disposed in between the exterior walls and the interior walls.

20. The system of claim 19, wherein the exterior walls and/or the interior walls are formed from a metal.

21. The system of claim 19, wherein the exterior walls and/or the interior walls are formed from plastic or a composite material.

22. The system of any of claims 19-21, wherein the thermally insulating material comprises a foam.

23. The system of any of claims 19-22, wherein the container is defined by a floor, side walls, and a cover.

24. The system of claim 23, wherein the floor, side walls, and/or cover of the container have an R-value of at least 4 square-foot*degree Fahrenheit*hour per British thermal unit per inch (ft^{2∗}°F^{∗}h/BTU^{∗}inch).

25. The system of claim 23 or claim 24, wherein a gasket is disposed between the cover and the side walls.

26. The system of any of claims 18-25, wherein the inlet pipe of the heat exchanger passes through an exterior wall of the container, thereby providing fluid communication between the plates and an exterior of the container.

27. The system of any of claims 18-26, wherein the outlet pipe of the heat exchanger passes through an exterior wall of the container, thereby providing fluid communication between the plates and an exterior of the container.

28. The system of any of claims 18-27, wherein:
a first end of the inlet pipe of the heat exchanger passes through a first exterior wall of the container, thereby providing fluid communication between the plates and an exterior of the container; and
a second end of the inlet pipe, opposite the first end, passes through a second exterior wall of the container.

29. The system of claim 28, wherein:
a first end of the outlet pipe of the heat exchanger passes through the first exterior wall of the container; and
a second end of the outlet pipe of the heat exchanger passes through the second exterior wall of the container, thereby providing fluid communication between the plates and an exterior of the container.

30. The system of claim 29, wherein:
the second end of the inlet pipe is capped, such that fluid communication between the plates and an exterior of the container is prevented through the second end of the inlet pipe; and
the first end of the outlet pipe is capped, such that fluid communication between the plates and an exterior of the container is prevented through the first end of the outlet pipe.

31. The system of claim 30, wherein the first exterior wall of the container and the second exterior wall of the container are in facing opposition to one another.

32. The system of any of claims 17-31, wherein the heat exchanger is at least partially embedded in the composition.

33. The system of any of claims 17-32, wherein a phase change material of the composition has a phase transition temperature within one of the following ranges:
450-550° C.;
300-550° C.;
70-100° C.;
60-80° C.;
40-50° C.;
16-23° C.;
16-18° C.;
15-20° C.;
6-8° C.; and
-40 to -10° C.

34. The system of any of claims 18-33, wherein:
the container comprises a first chamber and a second chamber separated by a divider wall;
a first portion of the n plates is disposed in the first chamber;
a second portion of the n plates is disposed in the second chamber;
the inlet pipe comprises a first valve having an open position and a closed position, the valve dividing the inlet pipe into a first portion and a second portion;
the first valve is substantially aligned with the divider wall;
a first end of the inlet pipe passes through a first exterior wall of the container;
a second end of the inlet pipe, opposite the first end, passes through a second exterior wall of the container;
a first end of the outlet pipe passes through the first exterior wall of the container;
a second end of the outlet pipe, opposite the first end, passes through the second exterior wall of the container;
the second end of the inlet pipe has an open configuration and a closed configuration; and
the second end of the outlet pipe has an open configuration and a closed configuration.

35. The system of claim 34, wherein:
the closed configuration of the second end of the inlet pipe is provided by a blind flange disposed over the second end of the inlet pipe; and/or
the closed configuration of the second end of the outlet pipe is provided by a blind flange disposed over the second end of the outlet pipe.

36. The system of claim 35, wherein:
the open configuration and the closed configuration of the second end of the inlet pipe are provided by a second valve disposed at the second end of the inlet pipe, the second valve having an open position and a closed position; and/or
the open configuration and the closed configuration of the second end of the outlet pipe are provided by a third valve disposed at the second end of the inlet pipe, the third valve having an open position and a closed position.

37. The system of claim 36, wherein:
the second valve is a flanged valve; and/or
the third valve is a flanged valve.

38. The system of any of claims 34-37, wherein:
the first end of the outlet pipe is sealed; and
when the first valve is in the open position, the second end of the inlet pipe is in the closed configuration, and the second end of the outlet pipe is in the open configuration, fluid flows simultaneously from both the first portion of the inlet pipe and also from the second portion of the inlet pipe, through both the first portion of the n plates and also through the second portion of the n plates, and then from the first portion of the n plates and also the second portion of the n plates into the outlet pipe.

39. The system of claim 38, wherein:
the first end of the outlet pipe is sealed; and
when the first valve is in the closed position, the second end of the inlet pipe is in the open configuration, and the second end of the outlet pipe is in the closed configuration, fluid flows from the first portion of the inlet pipe into the first portion of the n plates, then from the first portion of the n plates into the outlet pipe, then from the outlet pipe into the second portion of the n plates, and then from the second portion of the n plates into the second portion of the inlet pipe.

40. The system of any of claims 34-39, wherein:
a first composition according to any one of claims 1-12 is disposed in the first chamber; and
a second composition according to any one of claims 1-12 is disposed in the second chamber.

41. The system of claim 40, wherein the first composition and the second composition have the same composition and the same phase transition temperature, or have differing compositions and differing phase transition temperatures.

42. A method of storing and releasing thermal energy, the method comprising:
attaching a thermal energy storage system to an external source of an external fluid, wherein the thermal energy storage system comprises the system of any of claims 17-41.

43. The method of claim 42, wherein the external fluid is liquid water.

44. The method of claim 43, wherein the external source of the external fluid comprises an HVAC chiller or source of waste heat.

45. The method of any of claims 42-44 further comprising:
forcing a first portion of the external fluid through the heat exchanger of the thermal energy system.

46. The method of claim 45, wherein:
the first portion of the external fluid enters the heat exchanger at a first temperature (T1) and exits the heat exchanger at a second temperature (T2); and
T1 and T2 are different.

47. The method of claim 46, wherein T1 is higher than T2.

48. The method of claim 46, wherein T1 is lower than T2.

49. The method of any of claims 45-48, wherein:
the first portion of the external fluid participates in thermal energy exchange with the PCM composition disposed in the container.

50. The method of claim 49, wherein the first portion of the external fluid transfers thermal energy to the PCM composition, thereby lowering the temperature of the first portion of the external fluid.

51. The method of claim 50, wherein the PCM composition stores at least a portion of the transferred thermal energy as latent heat.

52. The method of claim 51 further comprising:
forcing a second portion of the external fluid through the heat exchanger of the thermal energy system;
transferring at least a portion of the stored latent heat from the PCM composition to the second portion of the external fluid, thereby increasing the temperature of the second portion of the external fluid.

53. The method of claim 49, wherein the phase change material transfers thermal energy to the first portion of the external fluid, thereby increasing the temperature of the first portion of the external fluid.

54. The method of claim 53, wherein the PCM composition transfers the thermal energy by discharging latent heat.

55. The method of claim 54 further comprising:
forcing a second portion of the external fluid through the heat exchanger of the thermal energy system;
transferring thermal energy from the second portion of the external fluid to the phase change material, thereby decreasing the temperature of the second portion of the external fluid.

56. A method of making a composition of any of claims 1-16, comprising:
providing the first PCM component;
providing the second PCM component;
providing the crosslinker, and
combining the first PCM component and the second PCM component with the crosslinker.
